(19) United States
(12) Patent Application Publication
(10) Pub. No.: US 2026/0346088 A1
(43) Pub. Date: Nov. 5, 2026

(54) Radar-Based AI Sports Training Feedback Platform

(71) Applicant: TAG Sports and Outdoor, LLC, Lawrence, KS (US)

(72) Inventors: Yilun Su, Beijing (CN); Jiachao Tang, Beijing (CN); Logan Tuel, Kansas City, MO (US); Luke Hornberger, Lawrence, KS (US); Zhenyu Hu, Overland Park, KS (US); Xiaoli Li, Lawrence, KS (US)

(21) Appl. No.: 19/634,656

(22) Filed: Mar. 31, 2026

Related U.S. Application Data
(60) Provisional application No. 63/798,424, filed on May 1, 2025.

(51) Int. Cl. A63B 24/00; A63B 71/06; G01S 13/58

(52) U.S. Cl. CPC A63B 24/0003; A63B 71/0619; G01S 13/58

(57) ABSTRACT

A computer-implemented method for providing personalized sports training feedback is disclosed. The method includes receiving radar signal data from a portable radar device in response to reflections from a moving sports projectile. The radar data is analyzed to extract performance metrics, which are stored in a training data repository linked to a user profile. An artificial intelligence engine processes the metrics alongside user-specific training context, such as historical performance and training goals, to generate processed data. Based on this data, the AI engine produces personalized feedback insights. The feedback is then presented to the user via a user interface in natural language form, enabling real-time, adaptive coaching and performance improvement.

### CROSS-REFERENCE TO RELATED APPLICATIONS

This application claims the benefit of U.S. Provisional Patent Application No. 63/798,424, filed May 1, 2025, pursuant to 35 U.S.C. § 119(e). The entire disclosure of the foregoing provisional application is incorporated by reference herein in its entirety for all purposes.

### TECHNICAL FIELD

This disclosure relates generally to sports performance analytics and, more specifically, to computer-implemented systems and methods for processing motion data captured by radar-based tracking devices. In particular, the disclosure relates to generating personalized sports training feedback using artificial intelligence techniques applied to performance metrics derived from radar signal data.

### BACKGROUND

In the field of sports performance measurement, radar-based tracking systems are widely used to capture motion characteristics of projectiles such as baseballs, softballs, and other sports equipment. These systems utilize radar techniques to detect velocity, trajectory, and rotational dynamics in real-time. Advances in miniaturized radar transceivers and signal processing architectures have enabled the development of portable and field-ready devices suitable for use by athletes, coaches, and trainers across a range of practice and competitive environments.

### SUMMARY

The systems, methods and devices of this disclosure each have several innovative aspects, no single one of which is solely responsible for the desirable attributes disclosed herein.

One innovative aspect of the subject matter described in this disclosure can be implemented in a computer-implemented method for generating sports performance metrics for a sports projectile using radar sensing during a sports event. The method includes receiving digitized radar return data representing reflections of radio-frequency transmissions from the sports projectile and performing a frequency-domain analysis on the digitized radar return data to determine Doppler frequency information associated with the sports projectile. The method also includes generating, from the Doppler frequency information, radar-derived launch metrics and forming an input feature vector that includes the radar-derived launch metrics and at least one additional feature derived from the digitized radar return data (e.g., a radar-echo or Doppler-spectrum feature associated with the projectile). The method further includes applying a machine-learning model to the input feature vector to generate a projectile-motion parameter and computing, using a deterministic computation module, a user-facing sports performance metric from the projectile-motion parameter. The method additionally includes outputting the user-facing sports performance metric for presentation.

Another innovative aspect of the subject matter described in this disclosure can be implemented in a computer-implemented method for generating sports performance metrics for a sports event involving a sports projectile. The method includes receiving radar-derived launch metrics that are generated from radar return data produced by a radar sensor observing the sports projectile, where the radar-derived launch metrics include at least an initial projectile speed and at least one launch angle. The method also includes forming an input feature vector that includes the radar-derived launch metrics and an optional radar echo feature or context feature, and applying a machine-learning model to the input feature vector to generate a projectile-motion parameter. The method further includes computing, using a deterministic computation module, a user-facing sports performance metric from the projectile-motion parameter, and outputting the user-facing sports performance metric for presentation.

Another innovative aspect of the subject matter described in this disclosure can be implemented in a non-transitory computer-readable medium storing instructions that, when executed by one or more processors, cause the one or more processors to perform operations for generating sports performance metrics for a sports projectile. The operations include receiving digitized radar return data representing reflections of radio-frequency transmissions from the sports projectile, performing a frequency-domain analysis on the digitized radar return data to determine Doppler frequency information associated with the sports projectile, and generating radar-derived launch metrics from the Doppler frequency information. The operations also include forming an input feature vector comprising the radar-derived launch metrics and at least one additional feature derived from the digitized radar return data, applying a machine-learning model to the input feature vector to generate a projectile-motion parameter, computing, using a deterministic computation module, a user-facing sports performance metric from the projectile-motion parameter, and outputting the user-facing sports performance metric for presentation.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram of an example sports feedback platform for a sports performance analysis that utilizes radar signal input.

FIGS. 2A–2D are schematic diagrams illustrating example radar-device placements and observation geometries for capturing radar returns from a pitched projectile during a pitching event.

FIGS. 3A–3D are schematic diagrams illustrating example radar-device placements and observation geometries for capturing radar returns during a batting event, including ball flight following contact.

FIGS. 4A–4D are schematic diagrams illustrating example sensor placements for a hitting setup, including radar-device placement and optional supplemental sensing.

FIG. 5 is a flow diagram of an example method for receiving radar signal data, extracting performance metrics, storing extracted metrics, processing metrics with user-specific context, generating feedback output, and presenting feedback to a user.

FIG. 6 is a block diagram of an example radar signal-processing and feature-extraction pipeline that generates radar-derived launch metrics and optional echo-signature features from digitized radar return data.

FIG. 7 is a block diagram illustrating an example processing architecture in which radar-derived launch metrics and optional features are provided to an AI expansion engine to generate predicted parameters that are used by a deterministic metric computation module to generate user-facing metrics for presentation.

FIGS. 8A–8B are diagrams illustrating example coordinate and geometric representations for a projectile trajectory, including evaluation relative to a reference plane/region and computation of displacement or distance measures.

FIG. 9 is a diagram illustrating example trajectory-derived metrics, including carry distance, rollout distance, total distance, launch angle, and angle of descent.

FIG. 10 is a flow diagram illustrating confidence-based metric output logic, including comparing a confidence score to a threshold and selectively performing fallback computation and/or smoothing/filtering before outputting metrics.

FIG. 11 is a block diagram of an example networked system in which a radar device, a computing device, and a cloud service communicate via a network.

FIG. 12 is a block diagram illustrating example data organization and processing across user profiles, sessions, event metrics, intermediate parameters, aggregation, and reporting/visualization.

FIG. 13 is a block diagram illustrating an example coaching-feedback generation pipeline that uses computed user metrics, historical/session aggregates, and user goals/context to generate recommendations and associated explanatory output for display.

FIGS. 14A–14C illustrate example user interface views for presenting computed metrics, including a trajectory view, a dispersion map view, and a trend view.

FIG. 15 is a block diagram of an example computing device architecture that may be used to implement one or more components of the sports feedback platform.

### DETAILED DESCRIPTION

Current approaches to sports performance tracking, particularly in sports such as baseball and softball, typically involve the use of standalone radar guns, high-speed video capture systems, and manual observation tools. Handheld or tripod-mounted radar guns are widely used to measure projectile velocity, such as pitch speed or bat exit velocity, and often require manual operation and line-of-sight alignment. More advanced setups may include motion capture cameras or multi-angle video systems that enable analysis of player mechanics, sometimes supplemented with wearable sensors or force platforms to gather biomechanical data. These tools are often used in controlled environments, such as indoor training facilities or designated bullpen areas, and frequently require multiple operators or specialized technical knowledge to deploy effectively.

Some performance tracking systems incorporate software platforms to log numerical data, display historical statistics, or generate basic summaries such as session averages. In limited cases, certain mobile applications provide overlays of video recordings with speed or timing data, allowing for visual review and manual annotation by coaches or players. A small number of commercially available platforms have introduced artificial intelligence-based features, often focused on video analysis to detect pitch type or bat motion; however, such systems typically operate independently of real-time radar input and often rely on post-session review.

Despite their widespread use, existing methods present several limitations that reduce their effectiveness and accessibility for many athletes, particularly those in non-professional settings. First, the majority of radar devices merely display raw values such as speed or distance without offering any form of real-time analysis or coaching feedback. This lack of contextualization makes it difficult for users to understand how the metrics relate to performance goals or training progress. Second, data from radar, video, and user annotations are frequently handled by separate systems, requiring users to manually correlate results, a time-consuming and error-prone process that undermines workflow efficiency.

Moreover, current tools generally fail to provide personalized insights. Most systems do not adapt their outputs to reflect an athlete’s historical performance, skill level, or training plan. As a result, users receive the same static data regardless of whether they are beginners or elite-level players. High-end video analysis tools, while capable of delivering more advanced insights, often demand complex setup procedures, including environmental calibration and precise camera alignment, which limits their use to specialized training facilities. These systems also tend to be cost-prohibitive and require expert interpretation, placing them out of reach for casual athletes, youth players, and grassroots programs.

Even when advanced features are available, such as video overlays or AI-generated pitch classifications, these features rarely operate in real-time and often require users to interpret data manually. This reliance on subjective evaluation introduces inconsistency and reduces the usability of the data for performance improvement. Altogether, the fragmented nature of data collection, limited personalization, operational complexity, and high cost create significant barriers to delivering meaningful, real-time feedback in everyday training environments.

Various aspects of the disclosure improve sports sensing and analytics technologies by providing methods, components, and systems that use radar sensing to generate sports performance information for a sports projectile during a sports event. In example implementations, a sports performance metric generation system observes a projectile in flight using a radar device and converts radar observations into actionable, user-facing performance metrics and training feedback that may be presented to an athlete, coach, or operator during training sessions and/or competitive play. By leveraging radar-based measurement and downstream inference, the system can deliver accurate performance outputs with low end-to-end latency, without relying on specialized high-end sensing infrastructure or constrained capture environments.

In some implementations, the system receives radar signal data (e.g., digitized radar return data representing reflections of radio-frequency transmissions from the sports projectile) and analyzes the radar signal data to extract radar-derived launch metrics. Example launch metrics include an initial projectile speed and one or more launch angles determined from Doppler frequency information. The system may then expand the extracted performance metrics using an AI engine by forming an input feature vector that includes the radar-derived launch metrics and at least one additional feature derived from the radar return data (e.g., a radar echo feature, a Doppler-spectrum-derived feature, and/or another signal-signature feature). Using the input feature vector, the AI engine applies a machine-learning model to generate one or more projectile-motion parameters and/or other inferred parameters not directly obtained from the radar-derived launch metrics alone. The system can then compute one or more user-facing sports performance metrics from the projectile-motion parameter(s) using a deterministic computation module, and output the user-facing sports performance metrics for presentation via a user interface. In some implementations, the system additionally stores extracted and/or expanded metrics in a training data repository, processes the metrics in combination with user-specific training context, and generates a feedback output based on the processed data for presentation to the user.

In some embodiments, the digitized radar return data includes in-phase and quadrature (I/Q) samples produced by an analog-to-digital converter coupled to a radar front-end. The system may condition the digitized radar return data using noise-reduction and clutter-suppression techniques, including filtering, windowing, baseline removal, and threshold-based suppression of non-projectile reflections. The frequency-domain analysis can include performing a Fast Fourier Transform (FFT) to identify Doppler frequency information (e.g., one or more Doppler peaks) attributable to the projectile, and event segmentation may be used to isolate a time window corresponding to a release event, launch event, impact event, and/or a portion of a flight interval.

In further implementations, the additional radar-derived features used in the input feature vector characterize aspects of a Doppler spectrum and/or time-varying Doppler behavior (e.g., an echo-signature representation), enabling inference of projectile-motion parameters such as a rotational parameter (e.g., a spin rate) and/or trajectory-related parameters. The deterministic computation module can apply rule-based, kinematic, geometric, and/or physics-informed computations to convert predicted projectile-motion parameter(s) into user-facing metrics suitable for presentation (e.g., carry distance, landing point, lateral deviation, apex, or other sport-appropriate outputs), while optionally treating the AI-generated parameter(s) as intermediate values used primarily for downstream computation. In some implementations, the system stores radar-derived launch metrics, inferred projectile-motion parameter(s), and/or user-facing sports performance metrics in association with a session identifier and timestamp to support historical tracking, trend analysis, and generation of personalized coaching feedback across multiple sports events.

In some implementations, the disclosure further relates to techniques for expanding sparse or minimal radar-derived measurements into a richer set of sports performance data using machine-learning. In certain embodiments, the machine-learning model is trained and/or deployed as a lightweight model configured for execution on mobile or embedded processors, and may be obtained via knowledge distillation from a larger teacher model (e.g., a foundation model such as a large language model), optionally using sports data augmentation and/or synthetic training examples to improve robustness and coverage across sports, venues, and equipment.

Particular aspects of the subject matter described in this disclosure can be implemented to realize one or more of the following technical improvements. The disclosed techniques improve the functioning of radar-based sensing and computing systems by converting noisy, high-rate radar return signals into a stable, compact event representation that is suitable for real-time metric generation. In example implementations, signal conditioning and event isolation reduce sensitivity to clutter, multipath artifacts, and non-projectile reflections, while Doppler-based extraction produces launch metrics that are repeatable across events. As a result, the system produces consistent projectile-motion characterization from radar observations in deployment environments that would otherwise yield unstable or unusable measurements.

In some implementations, the disclosed architecture improves computational efficiency and real-time operability by partitioning processing into radar-derived feature extraction and inference of a limited set of intermediate projectile-motion parameters, followed by deterministic computation of user-facing metrics. This hybrid structure allows a machine-learning model to predict a set of parameters rather than directly predicting every displayed metric from raw radar data, which reduces inference complexity, lowers processor load, and supports predictable latency on mobile or embedded hardware. The deterministic computation stage further provides a structured mapping from inferred parameters to user-facing metrics, which stabilizes output behavior across variations in radar signal quality and supports consistent output formatting and presentation.

### Example Sports Performance Feedback Platform

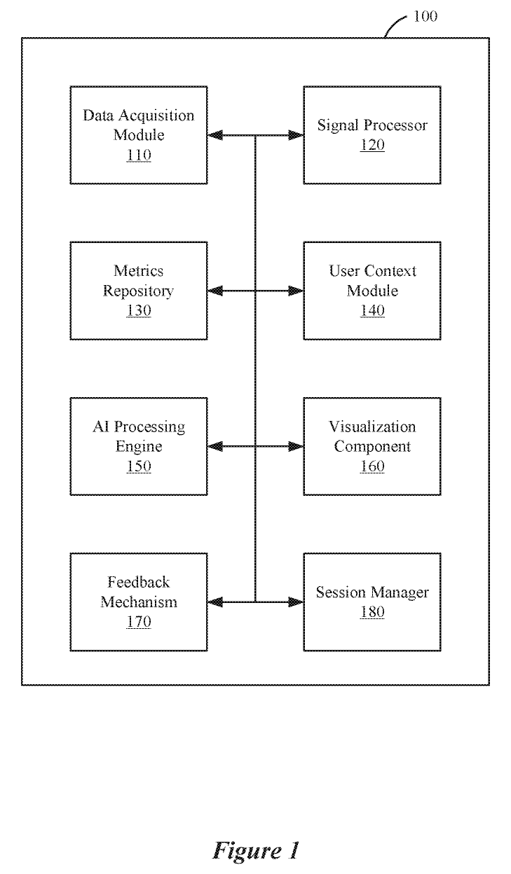

FIG. 1 shows a block diagram of an example of a sports performance feedback platform 100 for a sports performance analysis that utilizes radar signal input and artificial intelligence to generate personalized training feedback. In some examples, the platform 100 includes a set of functional modules that cooperatively enable end-to-end data acquisition, processing, analysis, and feedback delivery, including a data acquisition module 110, a signal processor 120, a metrics repository 130, a user context module 140, an artificial intelligence (AI) processing engine 150, a visualization component 160, a feedback mechanism 170, and a session manager 180.

As an example, the data acquisition module 110 can initially interface with radar sensors to capture motion data of sports projectiles (e.g., baseballs, golf balls, tennis balls, etc). Once collected, the signal processor 120 can extract meaningful performance metrics like pitch velocity, spin rate, or bat speed from the radar signal using techniques such as FFT-based Doppler analysis. These metrics can then be stored in the centralized metrics repository 130, which organizes data across sessions and users for easy retrieval.

The user context module 140 can enrich this data with individualized parameters like training goals, performance history, and physical condition. The AI processing engine 150 can synthesize these inputs to produce personalized coaching insights, which are delivered through a visualization component 160 and feedback mechanism 170. These components present the feedback in clear formats such as charts, summaries, or natural language messages. Overseeing the orchestration of these processes is the Session Manager 180, ensuring session continuity, synchronization, and proper association of data across all system components.

In some examples, the data acquisition module 110 is configured to obtain motion-related signal data corresponding to the movement of a sports projectile, such as a baseball, softball, or similar object, during a training or live play session. In some implementations, the data acquisition module 110 is communicatively coupled to one or more external sensing devices, including a radar sensor, a millimeter-wave transceiver, or a continuous wave (CW) Doppler radar unit. In other implementations, the sensing elements are integrated into a host computing platform (e.g., a mobile phone, embedded training device, or wearable sensor package) and operate under the control of the data acquisition module 110.

The data acquisition module 110 is operable to control the timing, activation, and configuration of the sensing hardware. In one example, the data acquisition module 110 may initiate a radar burst or sweep based on a user input, motion trigger, or predefined session start condition. The data acquisition module 110 may further configure sensor parameters such as carrier frequency, bandwidth, pulse repetition interval, or sampling rate depending on the intended training mode (e.g., pitching, batting, or machine-delivered repetition).

Upon activation of the sensor, the data acquisition module 110 can receive raw signal reflections resulting from radio frequency (RF) emissions interacting with the moving projectile. These reflections may be received as analog voltage signals or digitized in real-time by an analog-to-digital converter (ADC) coupled to the radar front-end circuitry.

In some aspects, the data acquisition module 110 is further configured to attach metadata to the captured signal data. This metadata may include a timestamp, sensor identification, geolocation coordinates, environmental conditions (e.g., ambient temperature, wind), or session-specific identifiers. The collected data and associated metadata may be encapsulated in a structured format, such as a signal packet or frame, and passed to downstream components, such as the signal processor 120, for further analysis.

In some examples, the data acquisition module 110 may operate continuously, periodically, or in response to discrete triggers depending on the configuration of the system. In a continuous mode, the data acquisition module 110 can stream data in real time to the signal processor 120. In a triggered mode, the module buffers data locally and initiates transfer only upon detecting a qualified event.

In some examples, the signal processor 120 is configured to process the raw motion-related signal data acquired by the data acquisition module 110 and to extract relevant performance metrics associated with the motion of a sports projectile. In various implementations, the signal processor 120 may be realized using dedicated digital signal processing (DSP) circuitry, general-purpose processors executing specialized software routines, field-programmable gate arrays (FPGAs), or a combination thereof.

The signal processor 120 is also configurable or configured to extract key kinematic parameters from the conditioned signal. For example, the signal processor 120 may perform a frequency domain analysis using Fourier transform techniques, such as the Fast Fourier Transform (FFT), to detect the peak Doppler frequencies associated with the movement of the projectile. These Doppler shifts are used to calculate real-time velocity data, including but not limited to pitch speed, ball exit velocity of a bat, or the travel velocity of a launched ball.

In some implementations, the signal processor 120 is operable to compute additional derivative metrics, such as acceleration, deceleration, launch angle, spin rate, or trajectory deviation. Spin rate detection, for instance, may involve analysis of subtle modulations in the Doppler spectrum, phase wrapping effects, or exploiting multi-channel radar setups that observe differential motion characteristics. In other cases, the signal processor 120 may apply machine-learning techniques to identify pitch types or swing patterns based on characteristic signal signatures.

The signal processor 120 may also perform event segmentation to distinguish valid motion events from noise or irrelevant activity. For example, the signal processor 120 may implement threshold detection algorithms, slope change detection, or energy-based event detection to isolate meaningful portions of the session where a pitch, hit, or ball release occurs. By segmenting data into discrete events, the signal processor 120 can accurately attribute each measurement to a corresponding session entry in the metrics repository 130.

In some embodiments, the signal processor 120 normalizes performance metrics across environmental conditions or device-specific calibration factors. For instance, metrics may be adjusted based on temperature variations, altitude changes, or minor sensor drift detected during use. Normalized metrics help ensure consistent user experience and comparability of training sessions conducted in different environments.

In some examples, the metrics repository 130 is configured to store and organize performance-related data derived from radar signal analysis during sports training sessions. It operates as a centralized or distributed data management component that maintains persistent, structured records of extracted performance metrics, session metadata, and associated user context information. The metrics repository 130 may be implemented in software, hardware, or a combination thereof and may reside locally on a user device, be hosted on a remote server, or span a hybrid architecture that synchronizes between local and cloud-based storage systems.

In operation, the metrics repository 130 can receive data from the signal processor 120, including performance metrics such as pitch speed, ball velocity, spin rate, acceleration, or angle of release. These metrics are stored in association with corresponding identifiers, including a timestamp, session ID, device ID, and user profile ID. The metrics repository 130 supports structured data storage formats such as relational tables, time-series databases, or hierarchical document-based stores (e.g., JSON, CSV, or XML records), which enable efficient retrieval and analysis of historical performance data.

The metrics repository 130 may additionally store auxiliary metadata related to the conditions under which each session was conducted. This may include environmental conditions (e.g., temperature, humidity), user-defined training modes, sensor configuration parameters, and contextual indicators received from the user context module 140. Such contextual data allows for enriched interpretation of the stored metrics, supporting personalized analysis and longitudinal trend evaluation.

In some embodiments, the metrics repository 130 is configured to support multi-user and multi-session indexing. It maintains an associative mapping between users and their respective sessions, enabling efficient retrieval of all metrics associated with a specific user or training timeframe. The metrics repository 130 may also store derived values or statistical aggregates computed over a defined range, such as rolling averages, maximum/minimum values, rate of change, or standard deviation, for use in comparative feedback and trend monitoring.

The metrics repository 130 may serve as a query backend for the AI processing engine 150. For example, when generating personalized insights, the AI engine may access a subset of historical data from the metrics repository 130 to compare current session metrics to a user’s baseline performance or to detect significant deviations from normal patterns. In this context, the metrics repository 130 acts as both a storage layer and a data provisioning component.

In some examples, the user context module 140 is configured to manage and maintain context-specific information associated with a user’s training profile, behavioral patterns, and performance objectives. The user context module 140 can serve as a contextual intelligence layer that augments raw performance data with user-specific attributes, thereby enabling the generation of personalized feedback, adaptive training pathways, and goal-oriented performance assessments.

In various embodiments, the user context module 140 is communicatively coupled to the metrics repository 130 and the AI processing engine 150. It receives and processes contextual data originating from multiple sources, including user-provided inputs, historical performance records, system-detected behavior patterns, and external data integrations (e.g., training schedules, third-party coaching tools).

The user context module 140 may maintain structured records that include static attributes such as age, sport, skill level, handedness (e.g., left- or right-handed pitcher or batter), dominant arm or leg, and training preferences. Additionally, it may store dynamic attributes such as current training goals (e.g., increase pitch velocity by 5% over 6 weeks), injury recovery status, recent workload, or fatigue indicators. These contextual inputs can be entered manually by the user via a user interface, imported from linked coaching systems, or inferred from observed performance trends over time.

In some implementations, the user context module 140 tracks session participation history, including frequency of training, intensity classification, and cumulative workload. These records allow the module to determine user-specific baselines and dynamically update them as the athlete progresses. For example, if a user consistently exceeds performance targets over a defined period, the user context module 140 may recalibrate expected performance ranges or suggest new stretch goals.

The user context module 140 may also maintain behavioral profiles that reflect a user’s response to different training conditions, times of day, recovery intervals, or environmental factors. In systems that support integration with wearable sensors or physiological monitors (e.g., heart rate, HRV, sleep tracking), the user context module 140 may incorporate biometric trends to infer user readiness or physical condition prior to engaging in a training session. This holistic perspective allows for adaptive feedback that is not only performance-based but also health- and recovery-aware.

Contextual data managed by the user context module 140 may be utilized by the AI processing engine 150 to customize feedback and performance evaluations. For instance, the same observed pitch velocity might be interpreted differently for a beginner versus an advanced athlete or for a fatigued user compared to one who is well-rested. The module 140 can ensure that the training system does not deliver generic or static evaluations but instead aligns outputs with the user’s developmental context and evolving status.

In some embodiments, the user context module 140 includes a goal management subcomponent that allows users or coaches to define, modify, and track training objectives. Goals may be quantitative (e.g., increase average bat speed by 10 mph) or qualitative (e.g., improve swing consistency) and may include defined timeframes, thresholds, or performance markers. The user context module 140 can track progress toward each goal and update goal status dynamically as relevant data is received from the metrics repository 130.

The user context module 140 may also support multi-user configurations, such as when the system is deployed in a team or coaching environment. In such cases, the module maintains separate contextual profiles for each user and provides session-based switching or automatic user recognition features. It may also include permission logic to allow coaches or authorized administrators to modify training parameters or review performance across multiple athletes.

In some examples, the AI processing engine 150 is configured to generate personalized training feedback and performance insights by analyzing performance metrics in conjunction with user-specific contextual data. Operatively coupled to the signal processor 120, metrics repository 130, and user context module 140, the AI processing engine 150 performs intelligent data interpretation, predictive analysis, and decision-making operations that enable a highly adaptive and individualized feedback system.

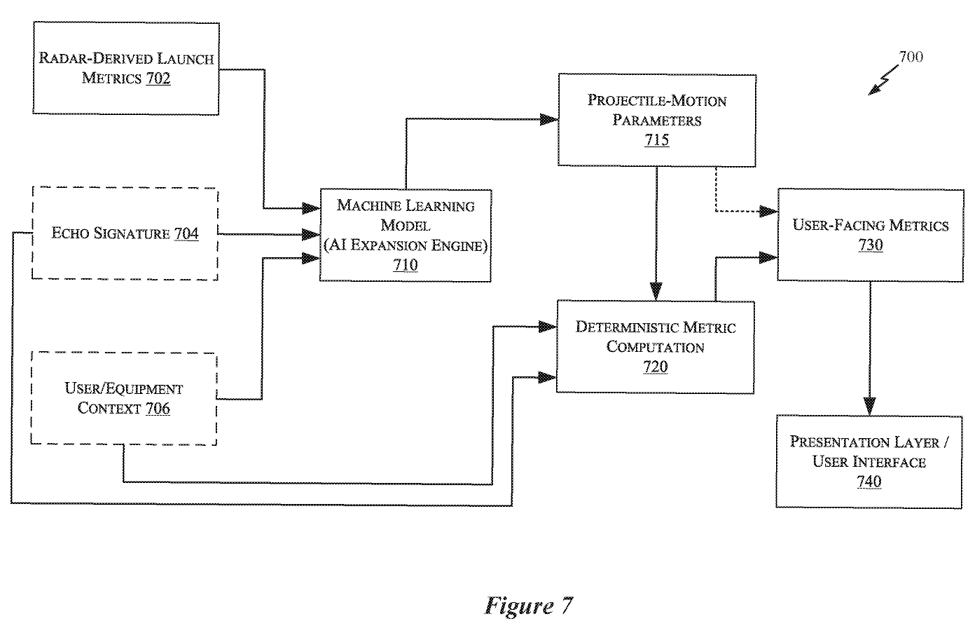

In some implementations, the AI processing engine 150 includes (or implements) an AI expansion engine configured to expand a compact set of radar-derived launch metrics into a richer set of inferred projectile-motion parameters that support downstream metric generation. For example, the AI expansion engine can apply a machine-learning model to radar-derived launch metrics provided by the signal processor 120, optionally together with one or more additional radar-echo features and/or user/equipment context, to generate intermediate predicted parameters used for subsequent computation of user-facing performance metrics. An example expansion architecture is described in further detail with respect to FIG. 7.

In some examples, the AI expansion engine operates on a feature representation (e.g., an input feature vector) that includes one or more event-level launch metrics such as initial speed, launch direction, and/or angular metrics, and may further include optional features such as Doppler-spectrum-derived echo-signature values, device calibration factors, device placement information, equipment identifiers, session settings, and/or user profile parameters. In some implementations, the AI expansion engine is configured to operate when one or more optional features are unavailable (e.g., by applying default values, using a learned representation for “unknown,” and/or conditionally omitting a feature), thereby supporting robust inference across varied sensor configurations and deployment conditions.

In some implementations, the intermediate outputs of the AI expansion engine include inferred parameters that are not directly obtained (or not reliably obtained) from the radar-derived launch metrics alone, such as a rotational state (e.g., spin rate and/or spin axis), trajectory state variables, aerodynamic parameters, and/or a landing-point estimate. The intermediate inferred parameters can be provided to a deterministic metric computation submodule (e.g., rule-based, geometric, kinematic, or other closed-form computations) that converts the intermediate inferred parameters into presentation-ready user-facing metrics, such as apex, carry distance, total distance, angle of descent, lateral deviation, induced break, and/or other sport-appropriate performance indicators. In this hybrid arrangement, the machine-learning component produces intermediate parameters, and the deterministic computation component produces the user-facing metrics selected for presentation.

In some examples, the AI processing engine 150 further generates a confidence score or other quality indicator associated with the inferred parameters and/or derived metrics, and the system can use the confidence score to control whether to output a full metric set, a reduced metric set, and/or metrics annotated with a quality flag. In various implementations, the intermediate inferred parameters, confidence values, and/or derived user-facing metrics can be stored in the metrics repository 130 in association with event/session identifiers to support longitudinal tracking, personalization, and subsequent coaching feedback generation.

In various embodiments, the AI processing engine 150 includes one or more computational models that operate on structured input data to generate output signals or feedback messages. These models may include machine-learning models, rule-based expert systems, statistical regression models, neural networks, or hybrid combinations thereof. The engine may utilize supervised, unsupervised, or reinforcement learning algorithms trained on historical data from individual users, groups of athletes, or anonymized global datasets.

The AI processing engine 150 can receive performance metrics from the signal processor 120, such as pitch speed, bat swing velocity, spin rate, release angle, and acceleration. It also receives contextual information from the user context module 140, such as training goals, baseline performance trends, fatigue indicators, skill level, or current training cycle phase. These data streams are combined to form an inference input set that reflects both the objective sensor-derived data and the subjective user-specific parameters necessary for individualized evaluation.

In one example, the AI processing engine 150 evaluates whether a user’s pitch velocity falls within an expected range given their recent training volume, fatigue level, and historical performance progression. If the velocity is trending below baseline for more than a defined threshold, the system may infer overtraining or mechanical inefficiency and output a rest recommendation or mechanical adjustment prompt. In another example, if a user’s exit velocity consistently exceeds previous highs while maintaining proper spin rates, the engine may identify this as a positive performance trend and suggest a progression in training load or update a goal target accordingly.

The AI processing engine 150 may include a feedback generation submodule, which translates inference results into human-readable insights. These insights may include progress summaries (e.g., “Your average pitch speed has increased by 4% over the last two weeks”), goal-tracking updates, anomaly alerts, or training recommendations. In some embodiments, the output includes actionable suggestions such as specific drills, rest intervals, or technique corrections based on model-generated classifications or predictive indicators.

In some implementations, the AI processing engine 150 includes a Natural Language Processing (NLP) component, which enables question-and-answer interactions with the user. This component may receive freeform user queries (e.g., “How am I doing compared to last month?”) and generate responses based on synthesized outputs from internal AI models, predefined knowledge bases, or third-party large language models, subject to domain-specific filtering and validation.

In some embodiments, inference execution may occur locally on the user’s device (e.g., smartphone or embedded processor) for low-latency feedback or offloaded to a cloud-based platform for more complex analysis. Hybrid implementations may allow initial processing to occur on-device, with batch training or deeper insights performed asynchronously on a remote server.

The output of the AI processing engine 150 can be provided to the visualization component 160 and the feedback mechanism 170 for presentation to the user in a user-friendly format, such as graphical plots, progress summaries, training notifications, or conversational interactions. The engine enables dynamic, user-specific coaching insights that evolve over time, creating a continuously adapting training environment that supports both immediate performance improvement and long-term development.

In some examples, the visualization component 160 is configured to generate and display graphical and textual representations of performance data, training trends, and personalized feedback derived from the AI processing engine 150. Operatively coupled to the AI processing engine 150 and the metrics repository 130, the visualization component 160 serves as the primary user interface layer for communicating system-generated insights in an intuitive, user-friendly format.

In various embodiments, the visualization component 160 renders time-series charts, performance gauges, comparative overlays, and trend indicators that reflect historical and real-time athletic performance. The visualization component 160 may include a graphical user interface (GUI) framework executable on a mobile application, tablet, smart device, or web-based platform, allowing the user to interact with visual content dynamically. The interface may support both live session feedback and post-session reviews and may adapt visual outputs based on user preferences or training context provided by the user context module 140.

The visualization component 160 may present individual performance metrics, such as pitch velocity, bat speed, spin rate, or acceleration, in real-time during a training session. In such cases, the visualization component 160 renders continuously updating graphs or numeric readouts that reflect the most recently processed data from the signal processor 120. These live metrics may be shown as dynamic progress bars, radial dials, or digital counters to maximize readability during active training.

In post-session or historical review modes, the visualization component 160 may generate aggregated summaries, such as average performance per session, trend lines over time, and milestone tracking. For instance, the visualization component 160 may display a line graph of pitch velocity over the past 30 days, annotated with markers indicating personal bests, target thresholds, or anomalies detected by the AI processing engine 150. Visualizations may also highlight user progress toward defined training goals using color-coded indicators, progress rings, or goal completion bars.

The visualization component 160 may also include controls for filtering and selecting data ranges, session types, or specific metrics to visualize. Users may toggle between views such as “Today,” “This Week,” “Last 30 Days,” or “Custom Range” and may select from a menu of performance metrics (e.g., exit velocity, launch angle, spin rate) to customize the visual display.

In team or multi-user implementations, the visualization component 160 may support role-based access and display modes. For example, a coach may view team-level summaries or individual athlete profiles, while athletes may view only their personal data. Administrative controls may also be provided to export visualizations or generate training reports in PDF or image formats for sharing with stakeholders.

In some configurations, the component is implemented with a responsive design to accommodate different screen sizes and orientations. For wearable or heads-up display systems, the visualization component 160 may employ minimal, high-contrast designs suitable for quick in-field review without user distraction.

In some examples, the feedback mechanism 170 is configured to generate and deliver actionable training guidance, status notifications, and personalized insights to the user based on the output of the AI processing engine 150. Operatively coupled to the visualization component 160, user context module 140, and optionally the session manager 180, the feedback mechanism 170 serves as the final delivery point in the system's analytics pipeline, translating raw metrics and analytical inferences into natural language and structured coaching output.

In various embodiments, the feedback mechanism 170 may be implemented as a software-based logic layer executing on a local device (e.g., smartphone, embedded sports radar unit, or tablet), a cloud-based service, or a hybrid system combining real-time and asynchronous feedback delivery. The feedback generated may be presented visually (via screen display), audibly (via speech synthesis or audio cues), or through tactile interfaces (e.g., haptic feedback or vibration alerts) depending on the training environment and device form factor.

The feedback mechanism 170 receives performance inferences and context-aware recommendations from the AI processing engine 150. These may include observations such as performance deviations, metric improvements, fatigue indicators, training goal status, and coaching suggestions. The feedback mechanism 170 can format these outputs into human-readable or machine-parsable messages, applying a feedback schema that considers priority, urgency, and delivery mode.

In some implementations, the feedback mechanism 170 generates real-time feedback during training sessions. For example, if a pitcher’s velocity drops below a target threshold for several consecutive throws, the module may immediately prompt a visual or audible notification, such as “Velocity down 5%. Consider adjusting grip or taking rest.” Similarly, if a user exceeds a personal record, the module may highlight the achievement with a celebratory alert and suggestion for next-level training objectives.

The feedback mechanism 170 may also generate session-end summaries, including consolidated performance statistics and natural language insights such as “You met 3 of 4 training goals today,” or “Spin rate improved by 150 RPM since last session.” These summaries may be further augmented with progress tracking visuals rendered via the Visualization Component 160.

In embodiments where the system supports training recommendations, the feedback mechanism 170 may output targeted practice drills or recovery protocols based on recent performance trends. For example, if inconsistencies in pitch release angle are detected, the system may suggest: “Practice 2-step delivery mechanics to reduce arm slot variability.” The feedback mechanism 170 may reference stored coaching content or integrate with external training libraries to deliver multimedia or text-based drill instructions.

The feedback mechanism 170 may further support adaptive goal feedback, dynamically adjusting training intensity or expectations based on cumulative user data. For instance, if progress toward a goal has plateaued, the feedback mechanism 170 may prompt the user to either revise the goal timeline or initiate a recovery phase, supported by evidence from the metrics repository 130 and contextualized through the user context module 140.

In some examples, the session manager 180 is configured to coordinate the operation, lifecycle, and data flow associated with individual training sessions within the sports performance feedback system. Operatively coupled to the data acquisition module 110, metrics repository 130, user context module 140, feedback mechanism 170, and optionally to external radar hardware or peripheral sensors, the session manager 180 serves as the central orchestration layer that enables seamless and structured training experiences for users.

In various embodiments, the session manager 180 can initiate and govern the operational state of a training session, including triggering the start and stop of radar data acquisition, timestamping recorded metrics, tracking user engagement, and aligning outputs from various system modules into a coherent session log. Sessions may be initiated manually through a user interface, automatically based on device proximity or motion detection, or in response to scheduled training routines stored in the user context module 140.

Upon initiation of a session, the session manager 180 can configure relevant system components, including setting operational parameters for radar sensing (e.g., sampling rate, mode of operation), activating signal processing workflows, and loading the current user profile and training context. It may further initialize any session-specific goal tracking or threshold monitoring processes based on goal definitions provided by the user context module 140.

During an active session, the session manager 180 can monitor and record metadata including session duration, time of day, environment tags (e.g., indoor/outdoor, temperature range), equipment identifiers, and user annotations. These parameters may be automatically detected or manually provided and are used to enhance the interpretability of the performance metrics captured during the session. The session metadata is stored alongside sensor-derived data in the metrics repository 130.

In some examples, the session manager 180 can ensure that performance metrics generated by the signal processor 120 are accurately associated with the correct session and user, and that time-series data is consistently aligned with feedback generation timestamps. In multi-sensor or multi-device configurations, the session manager 180 may also manage timing coordination, such as synchronizing radar capture from multiple viewpoints or aligning video input streams with radar-derived motion events.

In some implementations, the session manager 180 includes logic for pause and resume control, allowing users to temporarily suspend data collection during a session (e.g., between drills or repetitions) without losing continuity of context. It may also allow for session segmentation, where a single training block is broken down into multiple logical sub-sessions or events for more granular analysis.

In cloud-connected environments or multi-user systems, the session manager 180 may further facilitate data synchronization and upload, ensuring that all session artifacts are securely transmitted to a remote repository, such as a cloud-based athlete dashboard or coach portal. Access control, session visibility (e.g., private vs. shared), and collaboration features may also be governed by this module.

### Example Deployment Geometries

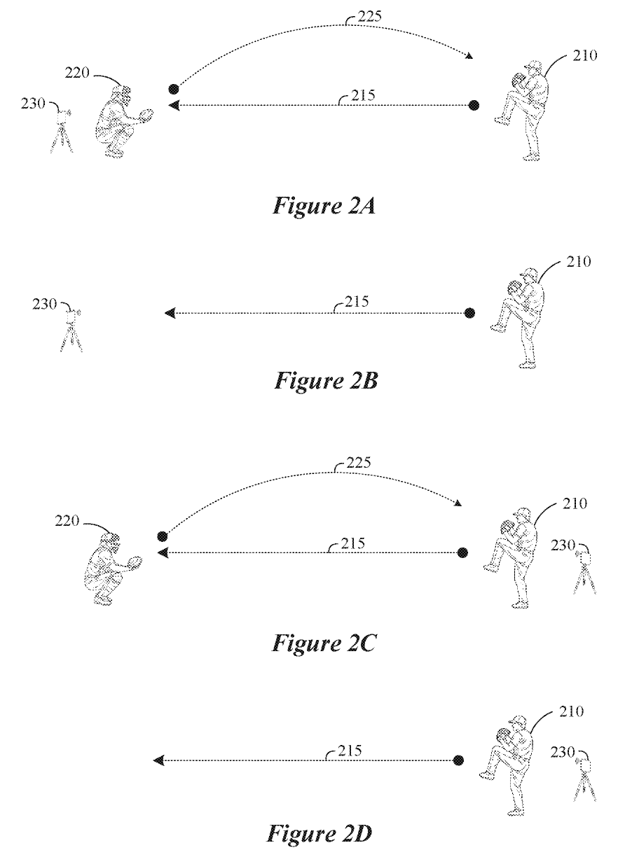

FIGS. 2A–2D are schematic diagrams illustrating example deployment geometries for a radar device 230 used to capture radar return data from a sports projectile (shown as a filled circle) during a pitching event. In the illustrated examples, a pitcher 210 releases the sports projectile to travel generally along a downrange direction indicated by dashed arrow 215 toward a receiving location (e.g., a catcher 220). A dashed curved line 225 represents an example non-linear projectile trajectory that can occur during flight as the projectile travels back to the pitcher from the catcher (e.g., due to gravity and/or spin effects), while the dashed arrow 215 represents a nominal direction of travel and/or a reference line used to describe observation geometry, radial-motion components, or metric computation.

FIG. 2A illustrates an example configuration in which the radar device 230 is positioned proximate to the receiving end of the pitching lane, such as near or behind the catcher 220. In this arrangement, the sports projectile travels from the pitcher 210 toward the catcher 220, and therefore generally moves toward the radar device 230 over at least a portion of the flight. This “downrange” placement can increase the radial component of projectile velocity relative to the radar device 230, which can improve Doppler-based estimation of speed and related launch metrics. FIG. 2A also depicts two representative projectile positions along the pitch lane (e.g., near release and near receipt), emphasizing that the radar device 230 may acquire returns over multiple time instants as the projectile traverses the lane.

FIG. 2B illustrates a simplified variation of the pitching geometry in which the radar device 230 is positioned along or near an extension of the nominal pitch direction 215 relative to the pitcher 210, with the receiving participant or target omitted for clarity. In some implementations, the configuration of FIG. 2B represents a training or capture setup in which the projectile is thrown toward a target plane, net, strike zone target, or other receiving structure that is not shown, while the radar device 230 acquires radar returns along the flight direction 215. By aligning the radar device 230 with the nominal projectile direction, the system can emphasize Doppler frequency content attributable to projectile motion along the pitch lane while reducing sensitivity to off-axis motion and/or non-projectile reflections in the surrounding environment.

FIG. 2C illustrates an example configuration in which the radar device 230 is positioned proximate to the pitcher 210 (e.g., near the release side of the pitching lane). In this “up range” placement, the radar device 230 can observe the projectile as it departs the pitcher 210 and travels downrange toward the catcher 220 along the nominal direction 215. This placement can be useful for capturing returns associated with early-flight dynamics (e.g., near-release speed behavior and/or other motion-related signatures) and can reduce occlusion from downrange participants or structures. As shown, FIG. 2C again depicts representative projectile positions along the pitch lane to illustrate that the radar device 230 may acquire radar returns across a time window that spans at least a portion of the projectile’s flight from release toward receipt.

FIG. 2D illustrates a simplified variation of the pitching geometry in which the radar device 230 is positioned proximate to the pitcher 210 (e.g., near the release side of the pitching lane) while the receiving participant or target is omitted for clarity. In the illustrated arrangement, the sports projectile travels generally along the nominal downrange direction indicated by dashed arrow 215, and therefore generally moves away from the radar device 230 over at least a portion of the flight. In some implementations, the configuration of FIG. 2D represents a training or capture setup in which the projectile is thrown toward a target plane, net, strike zone target, or other receiving structure that is not shown, while the radar device 230 acquires radar returns across a time window that includes near-release motion. This “up range” placement can be useful, for example, for capturing radar signatures associated with early-flight dynamics while reducing occlusion from downrange participants or structures.

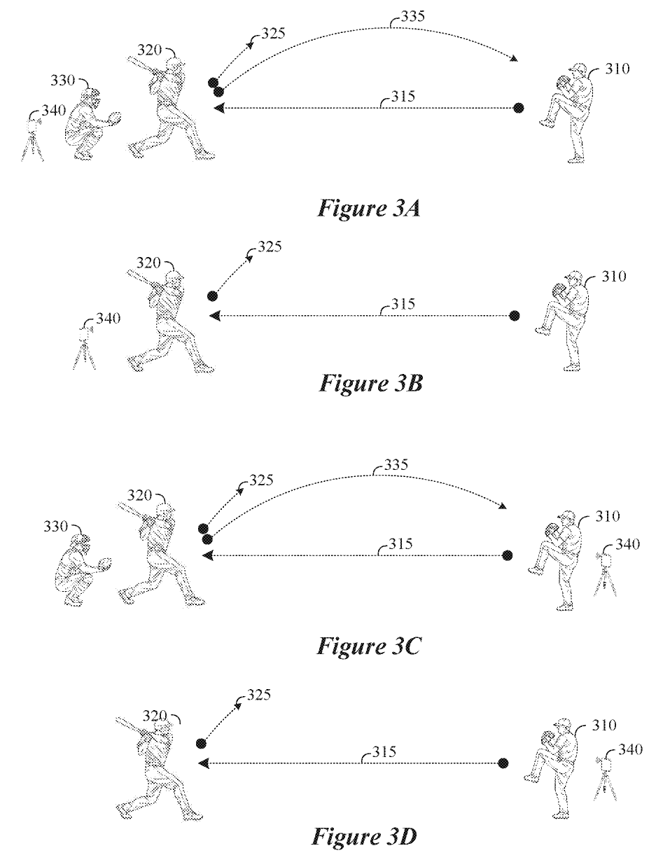

FIGS. 3A–3D are schematic diagrams illustrating example deployment geometries for a radar device 340 used to capture radar return data from a sports projectile during a batting event. In the illustrated examples, a pitcher 310 delivers the sports projectile along a nominal pitch direction indicated by dashed arrow 315 toward a batter 320 positioned proximate to a hitting region. A dashed arrow 325 represents an example initial post-contact direction of the batted projectile, and a dashed curved line 335 represents an example flight path of the projectile being returned to the pitcher by the catcher 330 if no contact is made by the batter 320. As shown, multiple filled-circle projectile positions are included in certain figures to illustrate a time sequence that may include a projectile at or near release, a projectile approaching the batter prior to contact, and/or a projectile departing the bat after contact. In some implementations, the system uses the illustrated geometries to obtain radar returns for both the pitched projectile segment (e.g., along 315) and the post-contact segment (e.g., along 325), for example by isolating time windows corresponding to pre-contact and post-contact intervals.

FIG. 3A illustrates an example configuration in which the radar device 340 is positioned proximate to a receiving end of the pitch, such as behind or adjacent to a catcher 330 located behind the batter 320. In this arrangement, the pitched projectile travels generally toward the radar device 340 as it approaches the batter 320, which can increase the radial component of the projectile velocity relative to the radar device 340 for Doppler-based analysis of the pitched segment. Following contact, the batted projectile departs the batter 320 along the example direction 325 and may follow the example curved flight path downrange (e.g., into the field of play). This downrange placement can enable capture of radar returns during both the incoming pitch segment and, depending on geometry and occlusion, at least an initial portion of the outgoing batted-ball segment.

FIG. 3B illustrates a simplified variation in which the radar device 340 remains positioned proximate to the batter-side region (e.g., near home plate) while one or more additional participants (e.g., the catcher 330) are omitted for clarity. In the configuration of FIG. 3B, the radar device 340 can acquire returns for the pitch traveling along 315 toward the batter 320 and can further acquire returns corresponding to an initial outgoing batted-ball direction 325 following contact. In some implementations, FIG. 3B represents a batting-practice or training configuration in which the system emphasizes near-plate capture of the pitch segment and the immediate post-contact segment (e.g., for estimating exit speed and/or an initial launch direction) without requiring the radar device 340 to track a full long-range ball flight.

FIG. 3C illustrates an example configuration in which the radar device 340 is positioned proximate to the pitcher side (e.g., downrange from the batter 320, such as near the pitcher 310). In this arrangement, the pitch along 315 travels generally away from the radar device 340 as it approaches the batter 320, while the batted-ball segment, illustrated by initial direction 325, may travel generally toward, or across the field of view of, the radar device 340 depending on hit direction and elevation. This configuration can be useful for capturing radar returns associated with the outgoing batted-ball flight (e.g., for estimating longer-range trajectory-related parameters) while maintaining sufficient separation between the radar device 340 and the batter-side region.

FIG. 3D illustrates a simplified batting-event geometry in which the radar device 340 is positioned proximate to the pitcher-side region (e.g., near the pitcher 310) while one or more additional participants (e.g., a catcher) are omitted for clarity. In the illustrated example, the sports projectile is delivered along a nominal pitch direction indicated by dashed arrow 315 toward the batter 320, and following contact the batted projectile departs along an example initial post-contact direction indicated by dashed arrow 325. In some implementations, FIG. 3D represents a batting-practice configuration in which the system emphasizes capture of the post-contact segment (e.g., exit-speed and/or initial launch-direction estimation) while optionally also acquiring returns for at least a portion of the incoming pitch segment. This configuration can be useful, for example, where a simplified field setup is desired and where the radar device 340 is placed to favor observation of the outgoing batted-ball segment without requiring long-range tracking of the full flight.

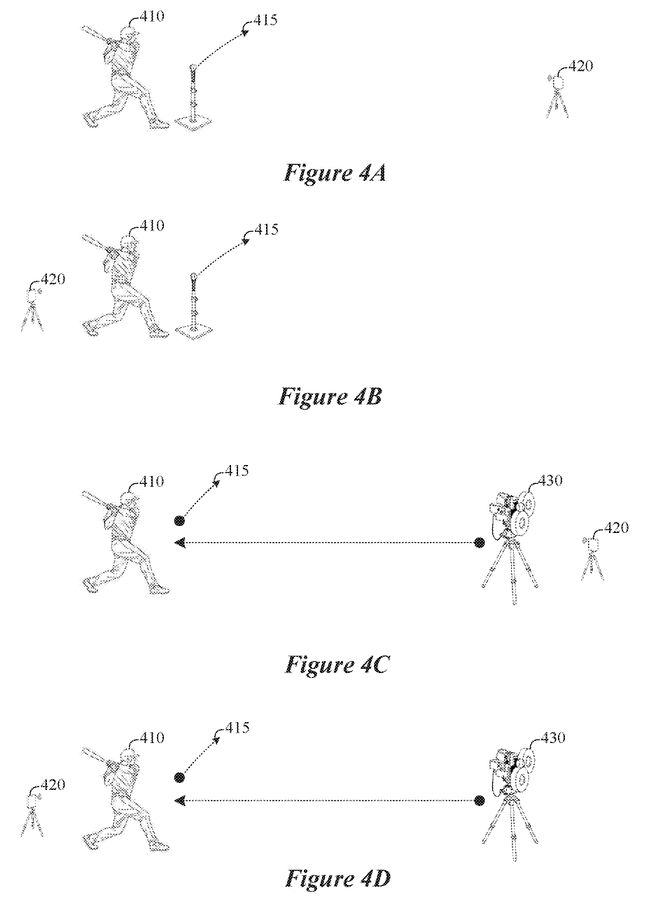

FIGS. 4A–4D are schematic diagrams illustrating example sensor placements for a hitting setup. In the illustrated examples, a batter 410 strikes a sports projectile supported by a tee, and the projectile departs along an example initial direction indicated by dashed arrow 415. The depicted placements show non-limiting examples in which a radar device 420 is positioned to acquire radar returns associated with the projectile immediately after contact and during at least a portion of early flight, and, in certain implementations, an additional sensing device 430 (e.g., an imaging device) is positioned to capture supplemental observations of the event.

FIG. 4A illustrates an example configuration in which the radar device 420 is positioned downrange from the tee and generally in the direction of expected projectile travel. In this arrangement, the projectile departs the tee in the example direction 415, and the radar device 420 can observe the projectile as it travels away from the batter 410. The downrange placement can be used, for example, to emphasize Doppler content attributable to early-flight motion along the travel direction and to reduce occlusion by the batter 410.

FIG. 4B illustrates an example configuration in which the radar device 420 is positioned behind or laterally offset from the batter 410. In this arrangement, the radar device 420 can acquire radar returns corresponding to the projectile immediately after contact along the example direction 415, while potentially providing a different observation angle than the downrange placement of FIG. 4A. This alternative placement can be useful, for example, in constrained environments where downrange placement is not feasible, or where an off-axis view is preferred to manage clutter, multipath, or line-of-sight constraints.

FIG. 4C illustrates an example configuration in which the radar device 420 is used in combination with a pitching machine 430 positioned downrange and oriented generally toward the batter 410. In the illustrated example, the pitching machine 430 delivers the sports projectile toward the batter 410 along a nominal pitch direction (shown by the dashed arrow extending from the pitching machine toward the batter). Following contact by the batter 410, the projectile departs along an example initial post-contact direction indicated by dashed arrow 415. In this arrangement, the radar device 420 is positioned proximate to the pitching machine 430 (e.g., laterally offset from the pitching machine 430) to acquire radar returns corresponding to the same event, including, in some implementations, radar returns associated with at least a portion of the pitched segment and at least an initial portion of the post-contact segment.

FIG. 4D illustrates an example configuration in which a pitching machine 430 is positioned downrange and oriented generally toward the batter 410, while the radar device 420 is positioned proximate to the batter-side region (e.g., behind or laterally offset from the batter 410). In the illustrated example, the pitching machine 430 delivers the sports projectile toward the batter 410 along the nominal pitch direction (shown by the dashed arrow extending from the pitching machine toward the batter), and after contact the projectile departs along the example initial post-contact direction indicated by dashed arrow 415. This batter-side placement can be useful, for example, in constrained environments where a downrange radar placement is not feasible, while still enabling the radar device 420 to acquire radar returns corresponding to the immediate post-contact motion of the projectile and, in some implementations, the incoming pitch segment.

### Example Flow Diagram

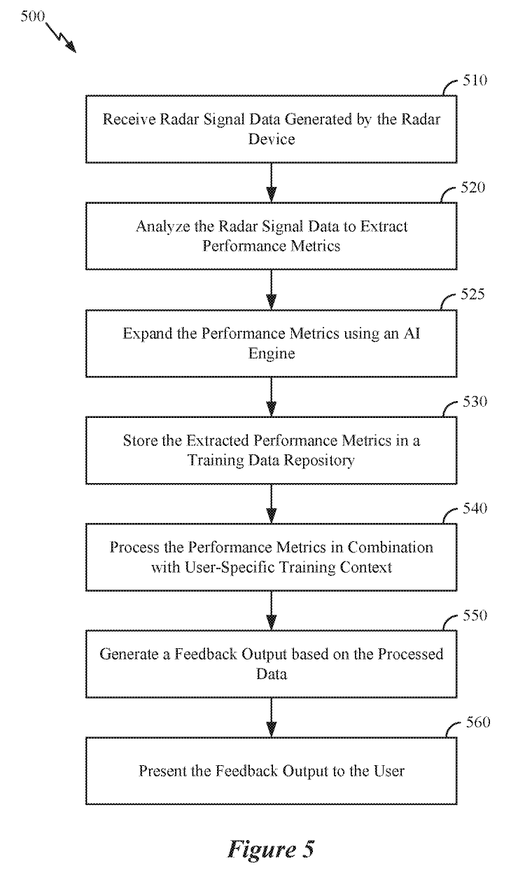

FIG. 5 is an example flowchart depicting an example process 500 performable by, or at, one or more computing devices of the disclosed sports performance feedback platform (e.g., platform 100) that supports generating sports performance information and training feedback from radar signal data. The operations of the process 500 may be implemented by the computing components described herein, including, for example, a computing device, such as the computing device 1500. In the illustrated implementation, the process 500 represents an end-to-end pipeline that begins with acquisition of radar signal data from a radar device and concludes with presentation of a feedback output to a user.

In some examples, at step 510, the system receives radar signal data generated by the radar device. The radar signal data can include digitized radar returns corresponding to reflections of radio-frequency transmissions from a sports projectile during a sports event, and may include digitized in-phase and quadrature (I/Q) samples produced by an analog-to-digital converter coupled to a radar front-end. In some examples, the received radar signal data is associated with metadata such as a timestamp, a session identifier, a device identifier, and/or user-identifying information for subsequent organization and retrieval.

In some examples, at step 520, the system analyzes the radar signal data to extract performance metrics. The analysis can include signal-processing operations that derive one or more radar-based metrics associated with projectile motion, such as speed-related metrics and/or angle-related metrics. In some implementations, the analysis includes performing a frequency-domain analysis (e.g., an FFT) on the digitized radar return data to determine Doppler frequency information associated with the sports projectile, and generating, from the Doppler frequency information, radar-derived launch metrics (e.g., an initial projectile speed and at least one launch angle). In some examples, step 520 further includes extracting additional radar-derived features usable for downstream processing, such as a radar echo feature derived from a Doppler spectrum representation, a Doppler-versus-time representation, a phase-derived feature, or another signal signature value associated with the sports projectile.

In some examples, the analysis of step 520 includes event segmentation to isolate a time window corresponding to a projectile release event, an impact event, and/or a launch event, thereby associating extracted metrics with a discrete sports event. In some implementations, the system conditions the digitized radar return data to reduce noise and non-projectile reflections prior to the frequency-domain analysis, for example, by clutter removal, baseline subtraction, gain control, and/or filtering.

In some examples, at step 525, the system expands the performance metrics using an AI engine. In some implementations, the AI engine forms an input feature vector comprising the radar-derived launch metrics and at least one additional feature derived from the digitized radar return data (e.g., a radar echo feature) and/or an optional context feature (e.g., user/equipment context). The AI engine can apply a machine-learning model to the input feature vector to generate one or more projectile-motion parameters and/or other inferred parameters not directly obtained from the radar-derived launch metrics alone. By way of example, the projectile-motion parameter can include a rotational parameter such as a spin rate and/or one or more trajectory-related parameters. In some implementations, the AI-generated projectile-motion parameters are treated as intermediate, non-displayed parameters used for downstream computation, rather than being output directly for presentation.

In some implementations, the machine-learning model applied at step 525 is a distilled lightweight model trained using sports data augmentation and a training dataset that includes real sports-event data, physics-based simulation priors, and/or synthetic training examples generated using a larger teacher model (e.g., a foundation model such as a large language model).

In an example embodiment for golf, the radar-derived launch metrics can include ball speed, one or more launch angles (vertical and/or horizontal), club speed, and, in some implementations, an attack angle, optionally together with an echo-signature feature and user/equipment context (e.g., club type, ball type, and/or user profile parameters). The AI expansion engine may infer rotational state (e.g., spin rate and spin axis), trajectory state, and/or a landing-point estimate, and may further predict one or more user-facing metrics directly from the radar-derived launch metrics and/or the inferred parameters. In some implementations, the deterministic computation module derives and/or refines one or more user-facing metrics based on the inferred parameters (and optionally the radar-derived launch metrics), such as apex, carry distance, total distance, angle of descent, side carry, and side total; whereas in other implementations, the AI expansion engine outputs one or more of these user-facing metrics without use of the deterministic computation module. In some implementations, the system computes club efficiency and shot consistency metrics using event-to-event dispersion and repeatability computed from a stored session history.

In some examples, forming the input feature vector includes constructing an echo-signature feature set (e.g., an echo signature vector) from one or more intermediate radar representations produced during radar processing. For example, the echo-signature feature set may characterize how Doppler content evolves over time (e.g., spectral spread, harmonic structure, modulation patterns, peak shape statistics, and/or other signature characteristics). In some implementations, these echo-signature features provide additional information correlated with projectile rotation and flight behavior that may not be fully captured by the radar-derived launch metrics alone.

In some examples, the input feature vector further includes an optional context feature (e.g., a user/equipment context feature), such as a device calibration factor, device placement information, session settings, equipment identifiers, or other context used to improve inference of projectile-motion parameters for the particular user, device, and/or operating conditions. In some implementations, the AI expansion engine is configured to operate when one or more optional features are unavailable (e.g., by using a default value, a learned embedding for “unknown,” or by conditionally omitting the feature), thereby supporting robust inference across varied deployments.

In some examples, the AI expansion engine applies the machine-learning model to the input feature vector to generate one or more predicted parameters that include a projectile-motion parameter and/or other inferred parameters not directly obtained from the radar-derived launch metrics alone. The machine-learning model may be implemented using one or more regression models, neural networks, ensembles, and/or other supervised or semi-supervised learning techniques trained to map the input feature vector to the predicted parameters. The machine-learning model can be configured to generate a plurality of projectile-motion parameters, including at least one rotational parameter and at least one trajectory-related parameter.

By way of example, the projectile-motion parameter(s) can include a rotational parameter comprising a spin metric, such as a spin rate, and, in some implementations, a related rotational characterization (e.g., spin direction and/or a spin-axis representation). Additionally or alternatively, the projectile-motion parameter(s) can include one or more trajectory-related parameters that parameterize aerodynamic or flight behavior, such as parameters usable to represent drag-related behavior, lift-related behavior, and/or lateral/vertical acceleration components over a portion of flight. In some implementations, these predicted parameters are selected to be suitable inputs to a subsequent deterministic computation stage that produces user-facing sports performance metrics (e.g., landing point, carry distance, total distance, apex, angle of descent, and/or lateral deviation).

In some examples, the machine-learning model is trained using a training dataset that associates radar-derived inputs (including radar-derived launch metrics and one or more additional radar-derived features) with reference projectile-motion parameters generated using higher-fidelity measurement techniques and/or curated ground-truth labels. In some implementations, the deployed model is a lightweight model configured for execution on a mobile or embedded processor (e.g., a model comprising fewer than a threshold number of parameters and/or configured to execute with an inference latency below a threshold), and may be obtained via knowledge distillation from a larger model, thereby preserving predictive quality while reducing compute and memory requirements.

In some implementations, training of the machine-learning model includes sports data augmentation applied to radar-derived inputs and/or intermediate feature representations. Example augmentation operations include applying perturbations that model device placement variation, environmental conditions (e.g., wind, temperature, altitude), equipment differences, sensor noise characteristics, and/or missing-data patterns, thereby improving robustness of inference when deployed with simplified radar sensing.

In some implementations, the training dataset comprises multiple sources of supervision, including real sports-event data captured by radar devices and labeled using higher-fidelity measurement techniques and/or curated ground-truth labels, physics-based simulations of projectile motion and/or contact events that generate synthetic labeled examples consistent with aerodynamic and/or kinematic constraints (e.g., drag and lift/Magnus effects, bounce/roll models, and other sport-appropriate dynamics), and/or synthetic or pseudo-labeled examples generated using one or more larger teacher models (e.g., a foundation model such as a large language model) that provide reference outputs for knowledge distillation and/or for expanding coverage of rare or difficult-to-capture scenarios.

In some implementations, the larger teacher model receives a representation of the radar-derived launch metrics, echo-signature features, and/or contextual features and produces reference projectile-motion parameters and/or expanded metric outputs (e.g., spin characteristics, trajectory state, and landing-point estimates). A lightweight deployed model (student model) is trained to approximate the teacher outputs and/or ground-truth labels, thereby reducing training time and data-collection cost while enabling adaptation across sports and device configurations. By way of example, the deployed model may comprise on the order of 10²–10⁶ parameters and/or may be configured for inference latencies of less than about 100 ms, such as 10–50 ms, on commodity mobile or embedded processors.

In some examples, at step 530, the system stores the extracted performance metrics (and, in some implementations, the expanded metrics and/or intermediate projectile-motion parameter(s)) in a training data repository. The training data repository may organize stored information by event, session, user, device, environment, and/or other metadata, and can accumulate historical records across multiple sports events. In some implementations, the system stores at least the radar-derived launch metrics and a user-facing sports performance metric (when computed) in association with a timestamp and a session identifier, thereby supporting longitudinal tracking and comparison.

In some examples, at step 540, the system processes the performance metrics in combination with a user-specific training context. The user-specific training context can include, for example, user profile information, training goals, historical performance data, session context, device calibration information, equipment identifiers, and/or environmental conditions. In some implementations, step 540 includes normalizing one or more of the radar-derived launch metrics, the projectile-motion parameter(s), and/or computed user-facing metrics based on an environmental condition and/or a device calibration factor to improve comparability across sessions and devices.

In some examples, step 540 further includes computing, using a deterministic computation module, one or more user-facing sports performance metrics from the AI-generated projectile-motion parameter(s). For example, the deterministic computation module can apply rule-based, kinematic, geometric, or other deterministic computations to generate user-facing metrics such as a landing point, carry distance, total distance, apex, angle of descent, lateral deviation, or other sport-appropriate outputs. In some implementations, intermediate projectile-motion parameter(s) produced by the machine-learning model are used internally to derive the user-facing metrics, and the user-facing metrics are the metrics selected for presentation.

In some examples, at step 550, the system generates a feedback output based on the processed data. The feedback output can include computed performance summaries, comparisons to historical baselines or targets, trend information, goal-tracking updates, and/or coaching guidance derived from the processed metrics and context. In some implementations, the feedback output includes personalized training insights generated by an AI processing engine that synthesizes current-event metrics with the user-specific training context (e.g., historical performance and training goals) and may be formatted as structured indicators and/or natural-language messages to improve interpretability.

In some examples, at step 560, the system presents the feedback output to the user, for example, via a user interface that renders the feedback output in a visual, textual, and/or natural language format suitable for real-time or post-event review. Presentation can occur on a mobile device, tablet, embedded display, or other computing device and may include interactive views that let the user review event-level metrics, session aggregates, and longitudinal trends.

Although the steps of FIG. 5 are shown in a particular order for purposes of illustration, in various implementations one or more steps may be combined, performed in a different order, repeated, or omitted, and portions of the process 500 may be executed on-device (e.g., at or near the radar device), on a companion computing device, and/or in a networked computing environment.

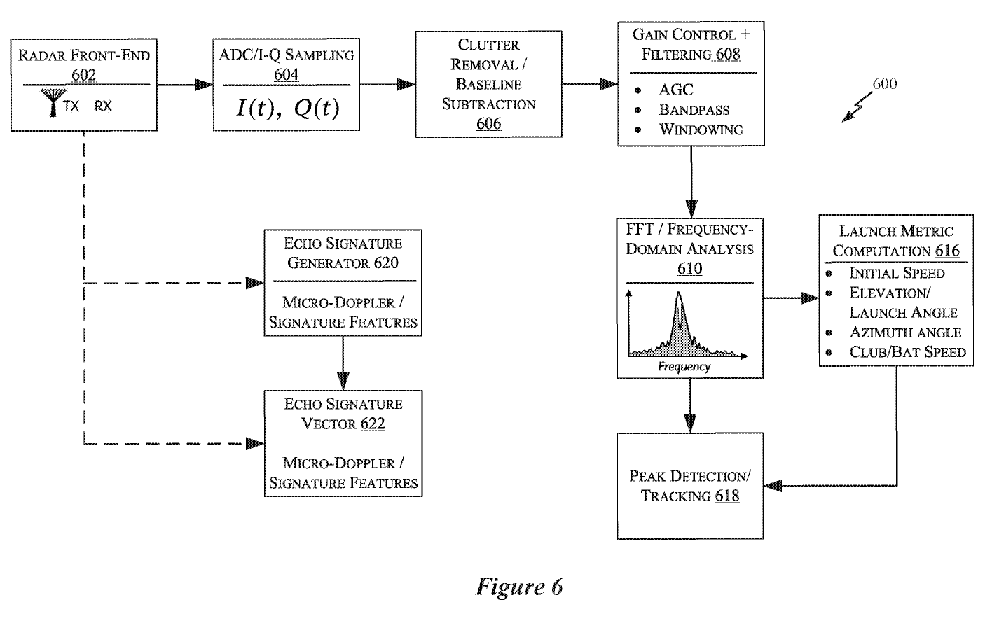

FIG. 6 is a left-to-right block diagram illustrating an example radar sensing and signal-processing pipeline 600 for generating radar-derived launch metrics and, optionally, an echo-signature feature set from radar returns associated with a sports projectile. In the illustrated implementation, a main processing path converts digitized in-phase and quadrature (I/Q) samples into Doppler information and launch metrics, and a branch path derives optional echo-signature features from one or more intermediate representations generated along the main path.

In the example of FIG. 6, a radar front-end 602 transmits one or more radio-frequency (RF) signals and receives RF reflections from the environment, including reflections from the sports projectile. The radar front-end 602 can include transmit circuitry, receive circuitry, and analog down-conversion circuitry configured to convert received RF reflections into an analog baseband or intermediate-frequency signal suitable for digitization. In some implementations, the radar front-end 602 produces quadrature analog channels corresponding to the in-phase and quadrature components of the received reflection signal.

The analog quadrature channels produced by the radar front-end 602 are digitized by an analog-to-digital conversion stage shown as ADC/IQ sampling 604. The ADC/IQ sampling stage 604 samples the analog in-phase and quadrature channels to generate digitized samples at a selected sampling rate. The digitized I/Q samples can form a time-series representation of the reflected radar signal, including motion-dependent phase and frequency content associated with the sports projectile.

The digitized samples can be provided to a conditioning stage, shown as clutter removal/baseline subtraction 606, to suppress non-projectile reflections and stabilize the signal prior to spectral analysis. In some implementations, the clutter removal/baseline subtraction block 606 reduces static or slowly varying returns (e.g., from the ground, netting, backstops, walls, or other structures) by subtracting a baseline estimate from the digitized signal. The baseline estimate can be computed, for example, as a running mean or median of the complex samples over time, a low-pass-filtered version of the complex samples, or another background estimate, and then subtracted from the incoming samples to emphasize motion-related components attributable to the projectile.

The output of block 606 is provided to a conditioning block shown as gain control + filtering 608 that adjusts signal amplitude and shapes the signal bandwidth to improve downstream Doppler extraction. In some implementations, the gain control + filtering block 608 performs one or more of automatic gain control (AGC) to normalize signal amplitude across events, bandpass or high-pass filtering to suppress low-frequency drift and residual clutter, and time-windowing of sample segments to reduce spectral leakage during Fourier transformation. The gain control + filtering block 608 can also include decimation or resampling, for example, to reduce computational load while preserving the Doppler resolution required for projectile tracking.

The conditioned signal produced by block 608 is then transformed into a frequency-domain representation by an FFT/frequency-domain analysis block 610. In some implementations, the FFT/frequency-domain analysis block 610 partitions the conditioned time-domain samples into frames (optionally overlapping), applies a selected window function to each frame, and computes a Fast Fourier Transform (FFT) to generate a Doppler spectrum for each frame. The resulting spectra provide Doppler frequency information about the sports projectile's radial motion relative to the radar device.

Doppler spectra generated by block 610 are provided to a peak detection/tracking block 618 that identifies Doppler components attributable to the sports projectile and tracks them over time. In some implementations, the peak detection/tracking block 618 computes magnitudes of Doppler bins, applies one or more thresholds to suppress noise-only bins, and selects one or more candidate peaks associated with the projectile return (for example, based on peak prominence, continuity across frames, and/or an expected Doppler range). The peak detection/tracking block 618 can associate peaks across successive frames to generate a time-varying Doppler track corresponding to the projectile during a time interval of interest.

The Doppler information from block 610 and/or the tracked Doppler peak(s) from block 618 are provided to launch metric computation block 616 to generate radar-derived launch metrics. In some implementations, the launch metric computation block 616 converts one or more Doppler peak frequencies to a radial velocity estimate (e.g., using a Doppler-to-velocity relationship based on the radar wavelength) and determines event-level launch metrics from the velocity estimate and/or Doppler track, such as an initial projectile speed and one or more launch angles. Where multiple receive channels or antenna elements are available, launch metric computation block 616 can additionally determine an angular metric (e.g., azimuth and/or elevation) based on inter-channel phase differences, amplitude comparisons, or another multi-channel angle-estimation technique. The launch metric computation block 616 outputs the radar-derived launch metrics for downstream use (e.g., as input to a machine-learning model or to populate a session record).

FIG. 6 further illustrates an optional branch for generating additional radar-derived features that characterize the projectile echo beyond the radar-derived launch metrics. In the illustrated example, an echo signature generator 620 derives one or more echo-signature features from the radar data and/or intermediate representations, such as from the conditioned I/Q samples, Doppler spectra, and/or the tracked Doppler peak(s). In some implementations, the echo signature generator 620 computes features that capture how the Doppler content evolves over time (e.g., modulation patterns, spectral spread, or other signature characteristics) and produces a structured output shown as an echo signature vector 622. The echo signature vector 622 may be provided, together with the radar-derived launch metrics from block 616, as inputs to downstream processing (e.g., to improve inference of projectile-motion parameters or user-facing metrics).

FIG. 7 is a block diagram illustrating an example processing architecture 700 that applies a pipeline in which a machine-learning component produces intermediate parameters, and a subsequent deterministic computation component uses those parameters to generate user-facing sports performance metrics for presentation. As shown, the architecture 700 includes radar-derived inputs 702, an optional echo-signature input 704, an optional user/equipment context input 706, an AI expansion engine 710, predicted parameters 715, a deterministic metric computation module 720, user-facing metrics 730, and a presentation layer/user interface 740.

In the illustrated example, the radar-derived launch metrics 702 represent event-level metrics extracted from radar return data for a sports projectile (e.g., initial projectile speed and one or more launch angles). The dashed-line blocks echo signature 704, and the user/equipment context 706 represents optional inputs. The echo signature 704 can include one or more radar-echo features derived from the radar return data (e.g., Doppler-spectrum-derived features, phase-derived features, or other signal-signature values). The user/equipment context 706 can include context information such as a user profile, session settings, device calibration information, or equipment identifiers. As shown, the radar-derived launch metrics 702 and one or more optional inputs 704, 706 are provided to the AI expansion engine 710.

The AI expansion engine 710 implements a machine-learning model that operates on a feature representation derived from the received inputs (e.g., an input feature vector including the radar-derived launch metrics 702 and at least one additional feature from 704 and/or 706). The AI expansion engine 710 generates predicted parameters 715 that represent one or more projectile-motion parameters inferred from radar-derived launch metrics and any optional features. In some implementations, the predicted parameters 715 can include, for example, a rotational parameter (e.g., a spin metric) and/or one or more trajectory-related parameters. The predicted parameters 715 are treated as intermediate parameters used for downstream computation and, in the illustrated architecture, are not intended for direct presentation to the user.

The deterministic metric computation module 720 receives the predicted parameters 715 and computes one or more user-facing sports performance metrics based on the predicted parameters 715. In some implementations, the deterministic metric computation module 720 applies one or more rule-based, closed-form, geometric, kinematic, or otherwise deterministic computations that transform the predicted projectile-motion parameter(s) into user-facing performance metrics such as, for example, a landing point, carry distance, total distance, apex, angle of descent, or lateral deviation. As further shown, the deterministic metric computation module 720 may optionally receive the user/equipment context 706 (and/or other event context) to normalize, calibrate, or otherwise adjust the computed user-facing metrics for the event.

The user-facing metrics block 730 represents an output packaging layer that receives the computed metrics from the deterministic metric computation module 720 and prepares those metrics for presentation. In some implementations, the user-facing metrics block 730 selects a subset of computed metrics for display, formats computed metrics into a presentation-ready structure, and/or associates the computed metrics with event/session identifiers. Although the user-facing metrics block 730 is shown receiving information from the predicted parameters 715 and the deterministic metric computation module 720, the architecture 700 outputs user-facing sports performance metrics rather than the intermediate predicted parameters. Stated differently, the predicted parameters 715 remain internal computational outputs used to derive the user-facing metrics.

The presentation layer/user interface 740 receives the user-facing metrics from block 730 and renders them for presentation to a user, for example, via a mobile device, tablet, embedded display, or other user interface. In this manner, FIG. 7 visually distinguishes an inference stage that produces intermediate projectile-motion parameters from a deterministic computation stage that converts those intermediate parameters into user-facing sports performance metrics for display.

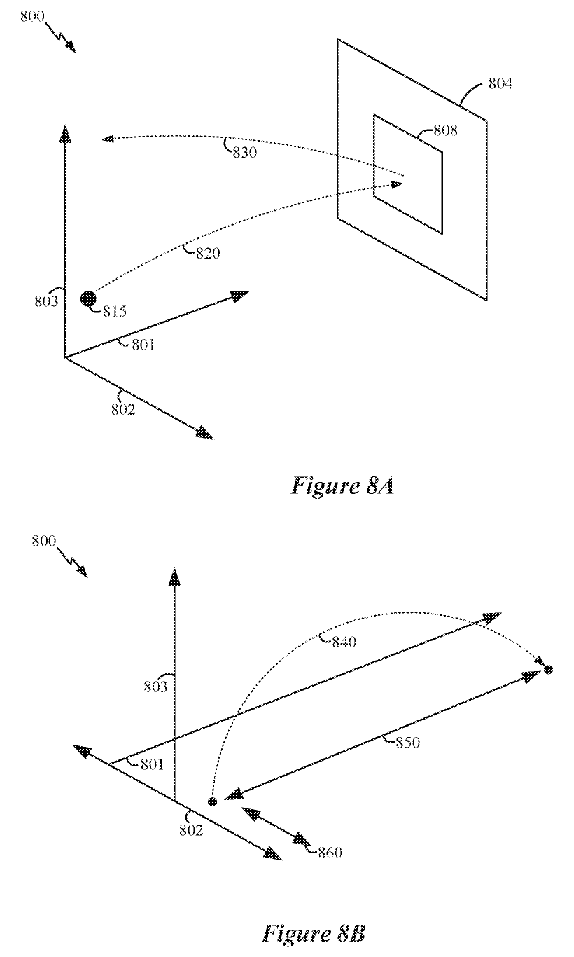

FIGS. 8A and 8B are diagrams illustrating example geometric representations used to evaluate a sports projectile trajectory in a reference coordinate system 800. In the illustrated examples, the coordinate system 800 includes three axes 801, 802, and 803 (e.g., a downrange axis, a lateral axis, and a vertical axis). The depicted axes and orientations are provided for purposes of illustration, and other coordinate definitions or axis assignments can be used depending on the sport, device placement, and reference frame.

FIG. 8A illustrates the evaluation of an example projectile trajectory relative to a reference plane 804 that represents a measurement plane, target plane, or evaluation plane (e.g., a plane at a predetermined distance from a release point, a plate plane, a net plane, or a catcher plane). A region 808 within the plane 804 represents an example target window (e.g., a strike-zone region, a goal window, or another acceptance region). A projectile position 815 represents an example starting or reference position (e.g., an initial position at release or immediately after launch). Dotted paths 820 and 830 illustrate example trajectories of the sports projectile from the projectile position 815 toward the plane 804, where the trajectories intersect the plane at respective locations. In some implementations, the system evaluates a predicted trajectory at the plane 804 to determine an intersection point and then computes one or more user-facing metrics based on the intersection point, such as a location at the plane, a height at the plane, a lateral offset, and/or a deviation relative to the region 808.

In some embodiments, the plane 804 and region 808 are used to support deterministic computation of performance metrics from intermediate projectile-motion parameters. For example, given a projectile-motion parameter that encodes a trajectory representation, the system can compute a trajectory-plane intersection location in the coordinate system 800, a distance from the intersection location to a reference point or boundary associated with the region 808, and/or a classification indicating whether the intersection location is within the region 808. These computed outputs can then be packaged as user-facing sports performance metrics for presentation.

FIG. 8B illustrates the decomposition of a projectile’s motion into one or more geometric components derived from a trajectory 840 in the coordinate system 800. In the illustrated example, the dotted arc 840 represents a projectile trajectory from an initial position (shown as a filled circle near the origin of the coordinate system) to a later position (shown as a filled circle at the end of the arc). A first vector 850 represents an example displacement component along a primary direction of travel (e.g., a downrange or forward component), and a second vector 860 represents an example displacement component along a transverse direction (e.g., a lateral component). In some implementations, these vector components are computed by projecting a trajectory displacement vector onto one or more axes of the coordinate system 800, and the resulting components are used to compute user-facing metrics such as downrange distance, lateral deviation, horizontal break, or other direction-specific displacement measures.

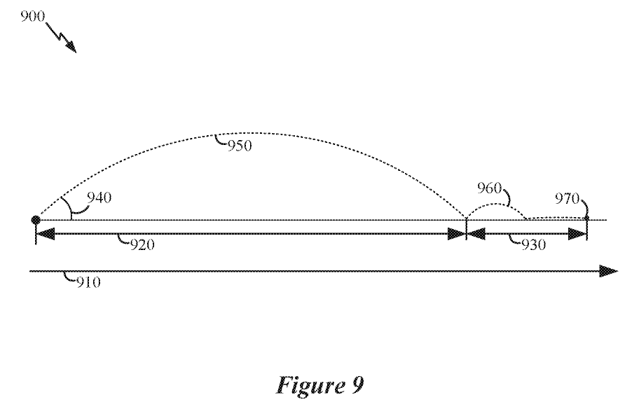

FIG. 9 is a schematic diagram illustrating an example two-phase computation 900 for determining the total distance of a sports projectile as a combination of an in-flight (carry) component and a post-landing (ground-interaction) component. The diagram is not to scale and is provided to illustrate how a user-facing metric (e.g., total distance) can be computed deterministically after a landing condition is determined from an intermediate projectile-motion representation.

In the illustrated example, a reference direction, or baseline 910, represents a downrange axis aligned with the nominal direction of travel. A projectile is launched from an initial position (shown as a filled circle at left) with an example launch angle 940 relative to the baseline. A dotted arc 950 represents an example flight trajectory during an in-air phase (i.e., prior to ground contact). The trajectory 950 terminates at a landing point on the baseline, which represents an example ground-contact location.

A first distance component, shown as carry distance 920, represents a downrange distance from the launch position to the landing point (i.e., the in-flight distance component). In some implementations, the carry distance 920 is determined by evaluating an intermediate projectile-motion parameter (e.g., a predicted trajectory representation) to identify the intersection of the trajectory with a ground plane or landing condition and then measuring the downrange displacement from the launch position to the landing point along the baseline 910.

A second distance component, shown as rollout distance 930, represents post-landing travel along the ground from the landing point to a final resting point. FIG. 9 depicts the transition from the flight phase to the ground phase at the landing point, and further illustrates an angle of descent 960 associated with the trajectory 950 at (or proximate to) the landing point. In some implementations, the angle of descent 960 (and/or other intermediate projectile-motion parameter(s) such as landing speed or landing direction) is provided to a deterministic rollout model that estimates post-landing motion.

The diagram further illustrates a ground-interaction parameter 970 associated with the ground phase. In some implementations, the ground-interaction parameter 970 represents one or more deterministic factors used to model post-landing travel, such as a surface condition classification (e.g., turf, dirt, synthetic surface), a friction or deceleration parameter, a firmness parameter, and/or a slope or grade parameter. Using the ground-interaction parameter 970, the rollout distance 930 can be computed deterministically (e.g., by applying a rule-based mapping or a deceleration model) to estimate how far the projectile travels after landing before coming to rest.

In the example of FIG. 9, the total distance can be computed as a combination of the carry distance 920 and the rollout distance 930. Accordingly, the figure emphasizes that total distance is not merely an in-flight quantity, but rather a user-facing sports performance metric that can be computed after landing by combining an in-air component derived from the trajectory 950 with a ground-interaction component determined by the rollout model.

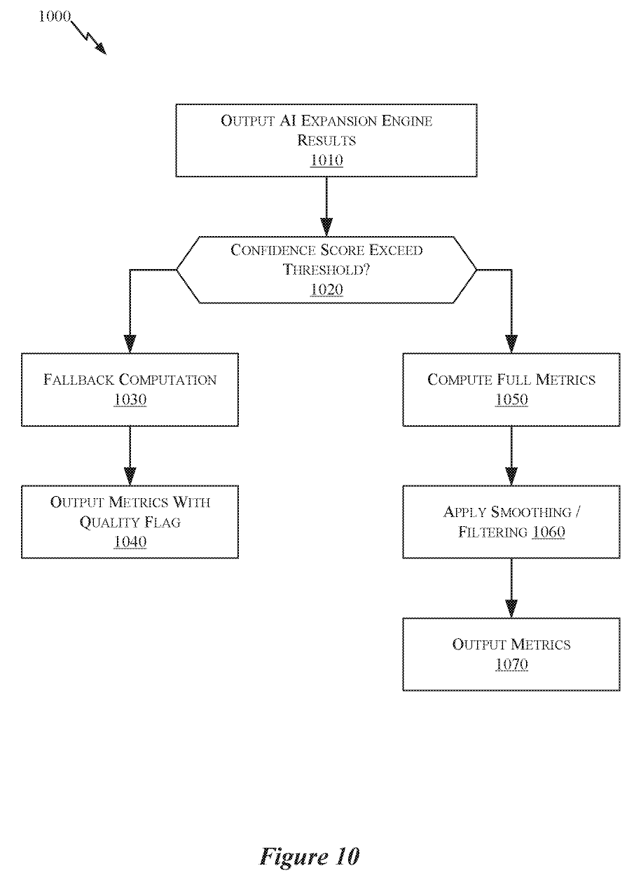

FIG. 10 is a flow diagram illustrating an example confidence-gated output process 1000 for generating and presenting user-facing sports performance metrics based on intermediate inference outputs produced by a machine-learning model (e.g., an AI expansion engine). The process 1000 illustrates how the system can use a confidence score (or other quality indicator) to control whether to compute and output a full set of user-facing metrics, or instead perform a fallback computation and output metrics with an associated quality flag. Although shown as a particular sequence for clarity, in various implementations, one or more operations may be combined, reordered, or performed in parallel.

At 1010, the system obtains or receives output from the AI expansion engine, which can include one or more intermediate inferred values such as projectile-motion parameters and/or other intermediate quantities produced from radar-derived launch metrics and optional features. In some implementations, the results at 1010 are the intermediate outputs generated by applying a machine-learning model to an input feature vector that includes radar-derived launch metrics and one or more additional features (e.g., an echo signature feature and/or user/equipment context).

At 1020, the system determines whether a confidence score exceeds a threshold. The confidence score can be associated with the AI expansion engine results from 1010 and can serve as a measure of the reliability or quality of the inferred intermediate outputs. In some implementations, the confidence score is derived from one or more indicators such as signal quality measures, strength or stability of detected Doppler components, consistency checks across time windows, model uncertainty measures, and/or other quality-of-service indicators. The threshold comparison at 1020 selects between a “full-metrics” path and a “fallback” path.

If the confidence score does not exceed the threshold, the process proceeds to fallback computation 1030. In the fallback computation 1030, the system computes a reduced or alternative set of metrics using a fallback logic path, which can be configured to reduce sensitivity to uncertain intermediate outputs. In some implementations, the fallback computation includes computing a subset of metrics using more conservative assumptions, relying on a reduced set of intermediate parameters, using simplified deterministic computations, and/or outputting a last-known-good metric estimate.

After fallback computation, the system outputs metrics with quality flag 1040. In the illustrated example, the quality flag indicates that the output metrics were produced via the fallback path and may have lower accuracy or completeness than a full-metrics output. In some implementations, the quality flag is included as metadata on the output so that the user interface can display a warning, a confidence indicator, or another qualifier.

If the confidence score exceeds the threshold at block 1020, the process proceeds to compute full metrics at 1050. In the compute full metrics operation 1050, the system computes a full set of user-facing sports performance metrics based on the AI expansion engine results. In some implementations, the compute full metrics operation applies a deterministic computation module to convert one or more intermediate projectile-motion parameters into user-facing metrics, such as landing point, carry distance, total distance, apex, angle of descent, and/or lateral deviation.

After computing full metrics, the process applies smoothing/filtering 1060. In the smoothing/filtering operation 1060, the system can apply one or more filtering operations to stabilize displayed outputs, for example, by reducing frame-to-frame jitter, suppressing outliers, or improving continuity of metrics reported across a short time interval. In some implementations, smoothing/filtering includes one or more of temporal filtering, moving-average filtering, median filtering, exponential smoothing, or other outlier rejection or stabilization logic.

The process then outputs metric 1070, which presents the computed user-facing sports performance metrics. In this manner, FIG. 10 illustrates an example reliability mechanism in which confidence gating controls whether metrics are computed and presented via a full path (with optional smoothing/filtering) or via a fallback path with an associated quality indication.

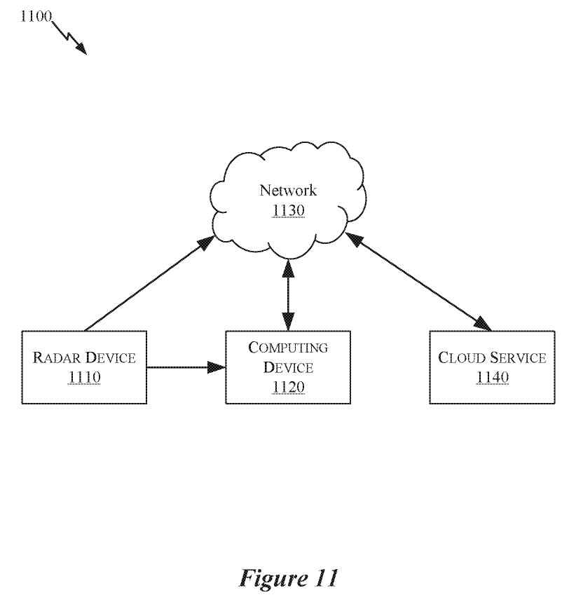

FIG. 11 is a network diagram illustrating an example deployment configuration 1100 in which a radar device 1110 is external to, and communicatively coupled with, a computing device 1120 that executes at least a portion of the sports performance metric generation pipeline. In the illustrated configuration, the radar device 1110 communicates with the computing device 1120 directly and/or via a network 1130, and the computing device 1120 optionally exchanges data with a remote cloud service 1140 via the network 1130. The arrangement of FIG. 11 is provided to show that the sensing hardware (radar device) can be physically separate from the processing and presentation hardware, while still enabling the claimed processing steps to be performed on mobile, edge, and/or cloud compute resources.

The radar device 1110 can include a radar front end and associated circuitry configured to transmit radio-frequency (RF) signals and to receive RF reflections from the environment, including reflections from a sports projectile during a sports event. In some implementations, the radar device 1110 digitizes radar return signals (e.g., digitized I/Q samples) and outputs digitized radar return data or other derived radar data to the computing device 1120. The radar device 1110 can be a standalone sensor unit positioned near a training area (e.g., behind a catcher, near a batter box, or downrange of a tee). It can communicate using any suitable wired or wireless data link, such as Bluetooth, Wi-Fi, USB, or another interface.

The computing device 1120 can be any suitable processor-based system, such as a smartphone, tablet, laptop, embedded processor, or dedicated edge compute module. In some implementations, the computing device 1120 receives the digitized radar return data (or radar-derived launch metrics generated by the radar device 1110) and performs one or more stages of the pipeline described in this disclosure, such as conditioning, frequency-domain analysis (e.g., FFT-based Doppler extraction), launch metric generation, feature-vector formation, machine-learning inference to generate intermediate projectile-motion parameters, and/or deterministic computation of user-facing sports performance metrics. The computing device 1120 can also implement a presentation layer to display computed metrics to a user in real time or near real time.

The network 1130 represents one or more communication networks that provide connectivity between the radar device 1110, the computing device 1120, and the cloud service 1140. The network 1130 can include one or more local networks (e.g., a home or facility Wi-Fi network), wide-area networks (e.g., cellular), and/or the Internet. Although FIG. 11 depicts network connectivity as a cloud icon for clarity, the network 1130 can include multiple hops and multiple communication protocols, and data exchange can be intermittent or continuous depending on the implementation.

The cloud service 1140 can provide remote compute and storage capabilities that complement or extend the processing performed by the computing device 1120. In some implementations, the cloud service 1140 stores event records, session histories, user profiles, and computed metrics; performs aggregation across sessions; generates longer-term trend analyses; and/or provides model management functions such as distributing updated machine-learning models to the computing device 1120. In further implementations, portions of the inference or deterministic metric computation can be executed by the cloud service 1140, for example when additional compute resources are available or when batch processing of historical data is desired.

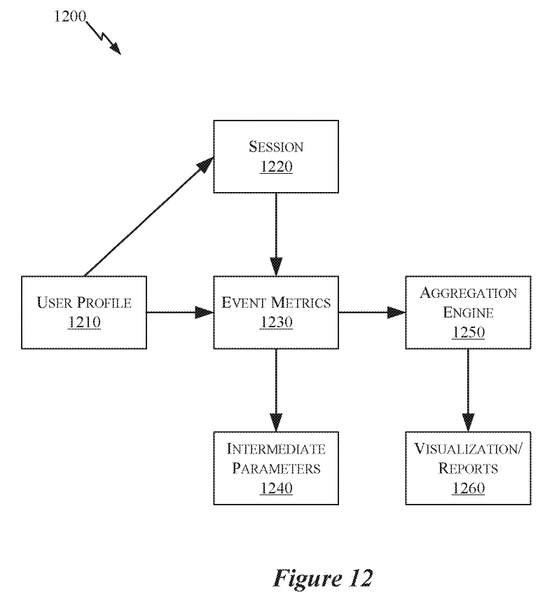

FIG. 12 is a block diagram illustrating an example data organization and processing arrangement 1200 for managing event-level metrics, intermediate parameters, and session-level aggregation for a user. The diagram is presented in an entity-relationship style to show how data associated with individual sports events can be stored, associated with a session and a user profile, and processed to generate historical trends, consistency metrics, and reports for presentation.

In the illustrated example, a user profile 1210 represents user-specific information that may be used to personalize processing and reporting, such as a user identifier, demographic or skill-level attributes, training preferences, equipment identifiers, and calibration or configuration settings. The user profile 1210 is associated with a session 1220, which represents a bounded time period or activity grouping (e.g., a practice session, bullpen, hitting session, or round). In some implementations, the session 1220 includes metadata such as a session identifier, timestamps, a location, environmental conditions, and device configuration information.

The event metrics 1230 block represents a collection of per-event records generated for sports events occurring within the session 1220 and associated with the user profile 1210. Each event record can store, for example, radar-derived launch metrics, one or more computed user-facing sports performance metrics, and event metadata such as an event timestamp, a session identifier, and a device identifier. In some embodiments, the event metrics 1230 are linked to intermediate parameters 1240, which represent intermediate inferred values (e.g., projectile-motion parameters) generated by a machine-learning model and retained for auditability, later recomputation, quality analysis, or model improvement. The intermediate parameters 1240 can be stored as an optional associated record per event and may be distinct from the user-facing metrics that are presented to the user.

The aggregation engine 1250 receives event metrics from event metrics 1230 and performs cross-event analysis across multiple events and/or sessions. In some implementations, the aggregation engine 1250 computes one or more higher-level summaries such as rolling averages, distributions, dispersion measures, best-of-session values, and consistency metrics that quantify repeatability or variability across events (e.g., standard deviation, median absolute deviation, interquartile range, or deviation relative to a target model). The outputs of the aggregation engine 1250 are provided to visualization/reports 1260, which can generate session summaries, trend charts, leaderboards, comparative analytics, and other reports for display via a user interface.

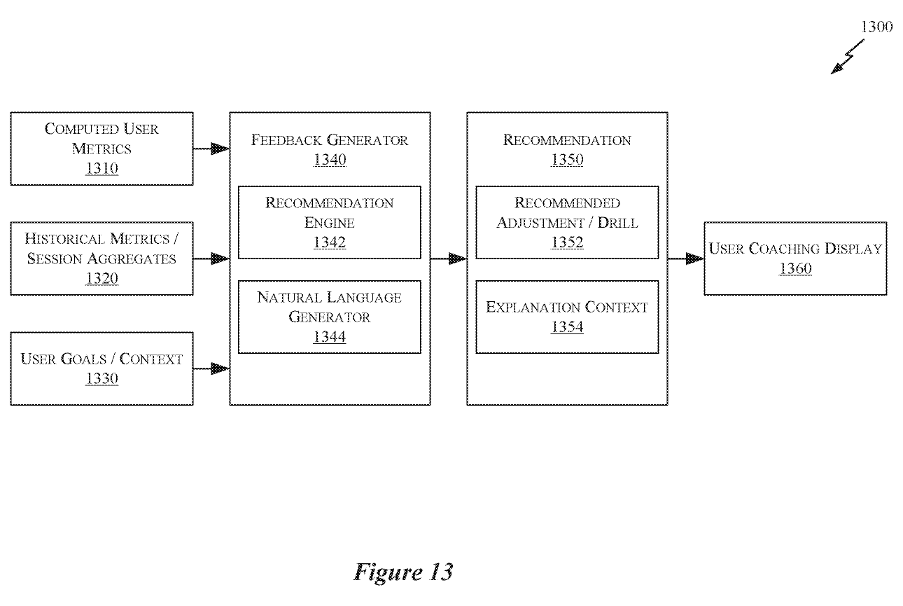

FIG. 13 is a block diagram illustrating an example coaching feedback generation pipeline 1300 in which computed user-facing sports performance metrics are further processed to produce actionable training guidance. In the illustrated implementation, the pipeline 1300 receives per-event computed user metrics 1310, historical metrics/session aggregates 1320, and user goals/context 1330, and produces a structured recommendation 1350 that is presented to a user via a user coaching display 1360. The arrangement in FIG. 13 is intended to show the downstream use of computed metrics, rather than merely displaying numeric results.

The computed user metrics 1310 can include one or more user-facing sports performance metrics computed for a particular sports event (e.g., a pitch, swing, shot, or hit), such as speed- and angle-related metrics, location-related metrics, distance-related metrics, and/or other event outputs computed from intermediate projectile-motion parameters. The historical metrics/session aggregates 1320 can include aggregated statistics computed across multiple events and/or sessions (e.g., averages, distributions, dispersion measures, trend indicators, and consistency measures). The user goals/context 1330 can include user-entered goals, coaching objectives, training plans, skill level, constraints, and/or equipment or environment context that may affect how the computed metrics are interpreted and what guidance is appropriate.

The inputs 1310, 1320, and 1330 are provided to a feedback generator 1340, which in the illustrated example includes a recommendation engine 1342 and a natural language generator 1344 block. The recommendation engine 1342 can implement deterministic or rule-based logic and/or one or more machine-learning models to transform the computed metrics into coaching actions. For example, the recommendation engine 1342 can compare computed user metrics 1310 to historical baselines and/or session aggregates 1320, evaluate deviations relative to a target model or goal described by user goals/context 1330, and select one or more recommended interventions (e.g., a drill, a technique adjustment, a focus area, or a parameter to emphasize in training). In some implementations, the recommendation engine 1342 outputs a recommended action and supporting rationale data (e.g., the metric(s) that triggered the recommendation, a delta versus baseline, trend direction, and/or a consistency indicator), and/or outputs a ranked set of candidate interventions with associated scores and/or confidence values.

In some implementations, the recommendation engine 1342 includes one or more trained models configured to generate the recommended intervention(s) using the inputs 1310–1330 (and optionally additional derived features), such as a classification model that selects an intervention category, a regression model that predicts an expected outcome or improvement magnitude, and/or a ranking model that assigns scores to candidate interventions for ordering and selection. Training data can include historical session data, labeled recommendations from coaches or domain experts, user feedback signals (e.g., acceptance, completion, or satisfaction), and/or observed performance changes over time (e.g., improvement in dispersion, consistency, or target metrics). In some implementations, the recommendation engine 1342 personalizes recommendations by conditioning on user profile parameters and/or learned user embeddings, and may apply deterministic constraints as guardrails (e.g., equipment- or capability-based constraints, minimum confidence thresholds, and/or exclusion rules) to filter, prioritize, or validate model outputs prior to generation of natural-language feedback by the natural language generator 1344.

The natural language generator 1344 can generate an explanation and/or instruction text corresponding to the recommendation engine output. In some implementations, the natural language generator 1344 formats a recommendation into user-consumable language using templates, structured phrase assembly, or model-based language generation, while preserving alignment to the underlying metric evidence. The natural language generator 1344 can incorporate elements from the user goals/context 1330 (e.g., “focus on control this session” vs. “focus on power”) and can reference historical comparisons from 1320 (e.g., “this session” vs. “last session”) to make the output more actionable and context-aware.

The recommendation 1350 represents the structured output of the feedback generator 1340, and includes a recommended adjustment / drill 1352 and an explanation context 1354. The recommended adjustment/drill 1352 can specify a concrete training action (e.g., a drill name, a suggested technique change, repetitions/targets, or a next-step task). The explanation context 1354 can include supporting information suitable for display (e.g., which metric(s) changed, the observed deviation, trend indicators, and/or other context for why the recommendation was selected). The recommendation 1350 is provided to the user coaching display 1360, which presents the recommendation and associated explanation to the user (e.g., via a mobile application, tablet interface, or embedded display), thereby enabling an athlete or coach to act on computed metrics in real time or during post-session review.

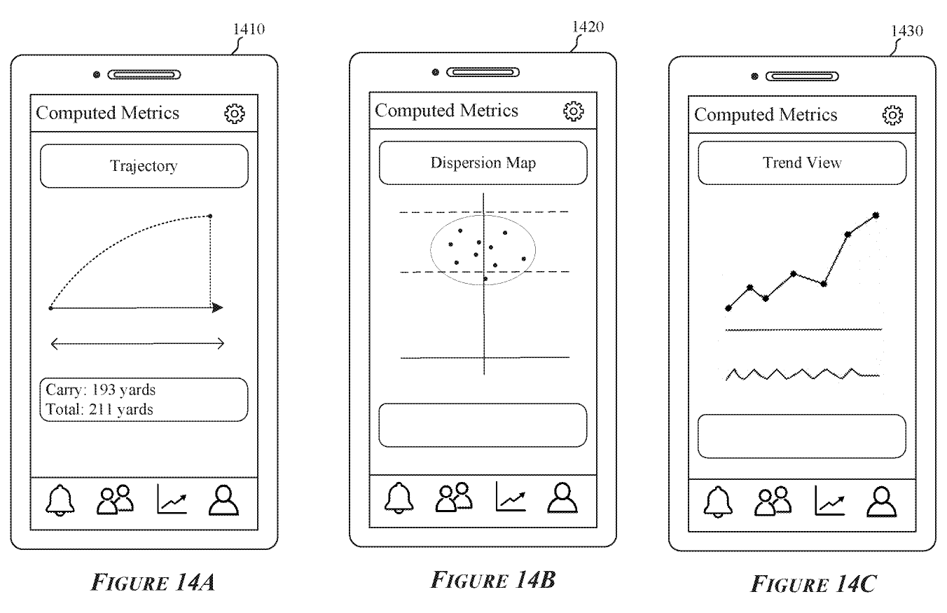

FIGS. 14A–14C illustrate example user interface views that can be presented by a computing device to display user-facing sports performance metrics computed for a sports projectile. In the illustrated examples, each view is shown on a computing device 1410, 1420, and 1430 (e.g., a smartphone or tablet) and includes a computed-metrics header region (“Computed Metrics”), a selectable view label (e.g., “Trajectory,” “Dispersion Map,” or “Trend View”), and one or more visualization panels that render computed outputs in a form that is readily interpretable by a user. Navigation controls and/or action icons are also shown to indicate that a user may switch between views, configure display settings, and access additional functions such as summaries, sharing, alerts, or coaching features.

FIG. 14A illustrates an example trajectory view presented on the computing device 1410. In the illustrated example, the trajectory view includes a trajectory visualization (shown as a curved path) representing an estimated or predicted flight of the sports projectile for a particular event, along with associated distance metrics. The view can present numeric user-facing metrics alongside the trajectory, such as carry distance and total distance (e.g., “Carry: 193 yards” and “Total: 211 yards”), and can optionally include visual indicators of direction, height, or other trajectory-derived characteristics. In some implementations, the trajectory view is generated from user-facing metrics computed after intermediate projectile-motion parameters are processed by a deterministic metric computation module, and the displayed values correspond to the metrics output for presentation to the user.

FIG. 14B illustrates an example dispersion map view presented on the computing device 1420. In the illustrated example, the dispersion map view displays a scatter of event outcomes (shown as multiple points), where each point represents a computed location associated with a respective sports event (e.g., a landing location, a target-plane intersection location, or another position-derived outcome). The view can include reference axes and/or a reference origin, as well as one or more reference boundaries (e.g., dashed lines) corresponding to a target region or acceptance band. The view can further include a dispersion indicator (e.g., an ellipse or confidence region) that represents variability across the plotted events. In some implementations, the dispersion map view supports consistency evaluation by allowing a user to visually assess clustering, bias (systematic offset), and spread (variability) across multiple events in a session or across sessions.

FIG. 14C illustrates an example trend view presented on the computing device 1430. In the illustrated example, the trend view displays one or more time-ordered plots of computed metrics across multiple events (e.g., a line plot with markers indicating per-event values), and can additionally present a secondary trend or stability visualization (e.g., a variability trace or smoothed indicator) to show how performance changes over time. In some implementations, the trend view supports session-level and longitudinal analysis by presenting trends for a selected metric (e.g., carry distance, speed, lateral deviation, or another computed output) and by enabling comparison across different time windows (e.g., within-session versus across sessions). The trend view can also be used as an entry point to coaching workflows by identifying metric changes, plateaus, or outliers that trigger recommendations or explanatory feedback presented to the user.

### Example Computing Environment

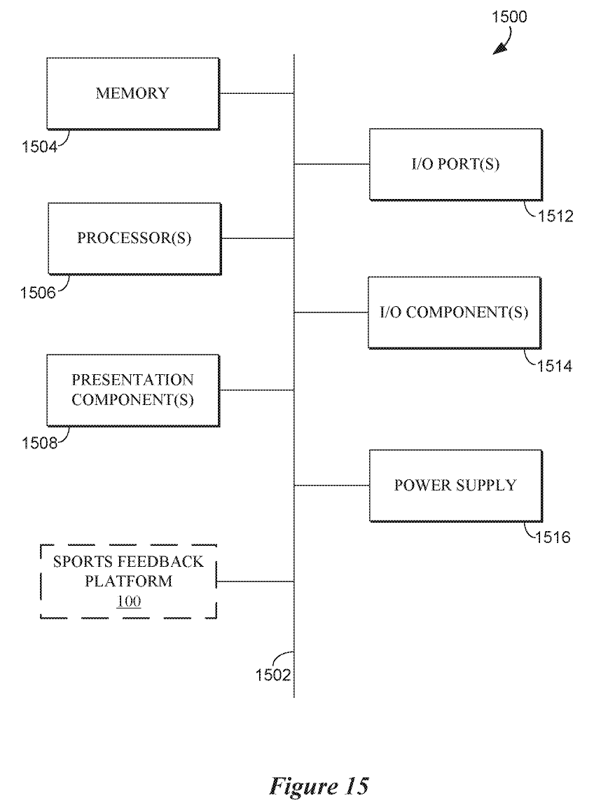

FIG. 15 illustrates an example block diagram of a computing environment 1500 suitable for implementing aspects of a sports training feedback platform 100, in accordance with one or more embodiments of the present disclosure. In some embodiments, the computing environment 1500 may include one or more processors 1506, memory 1504, and one or more input/output (I/O) ports 1512, each operably connected via a system bus 1502. The computing environment 1500 may further include one or more presentation components 1508 (e.g., a graphical display or mobile interface), one or more input/output (I/O) components 1514 (e.g., a keyboard, touchscreen, or sensor interface), and a power supply 1516.

As shown, the sports training feedback platform 100 may be implemented as executable software instructions stored in memory 1504 and executed by one or more processors 1506. In various embodiments, the sports training feedback platform 100 may include components corresponding to the system architecture described in FIG. 1, including a data acquisition module, signal processor, metrics repository, user context module, AI processing engine, visualization component, and feedback mechanism. These components may be implemented in software, hardware, or a combination of both, and may be embodied as part of a standalone computing device (e.g., mobile phone, tablet, or radar-integrated unit) or as part of a distributed system communicating over a network.

The memory 1504 may include both volatile and non-volatile memory and may store computer-executable instructions and data structures for performing one or more of the methods described herein. The presentation component(s) 1508 may be configured to display or transmit training feedback, performance metrics, session summaries, and system-generated recommendations to the user. The power supply 1516 may include a battery, power management circuitry, or other power-delivery subsystem suitable for portable or embedded operation.

In some embodiments, the computing environment 1500 may communicate with external sensors, radar devices, mobile applications, or cloud-based services via I/O port(s) 1512 or I/O component(s) 1514. For example, the computing environment 1500 may receive radar signal data via a connected Doppler radar sensor and output feedback through a paired mobile device or wearable component. The I/O components may support wireless protocols such as Bluetooth®, Wi-Fi®, or cellular data.

The architecture illustrated in FIG. 15 provides a general-purpose or special-purpose computing framework for implementing the sports training feedback platform 100, enabling real-time radar signal processing, AI-driven insight generation, and context-aware feedback delivery to athletes and coaches across a variety of training scenarios.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A computer-implemented method for generating sports performance metrics for a sports projectile, the method comprising:
receiving, by one or more processors, digitized radar return data representing reflections of radio-frequency transmissions from the sports projectile during a sports event;
performing a frequency-domain analysis on the digitized radar return data to determine Doppler frequency information associated with the sports projectile;
generating, from the Doppler frequency information, radar-derived launch metrics;
forming an input feature vector comprising the radar-derived launch metrics and at least one additional feature derived from the digitized radar return data;
applying a machine-learning model to the input feature vector to generate a projectile-motion parameter;
computing, using a deterministic computation module, a user-facing sports performance metric from the projectile-motion parameter; and
outputting the user-facing sports performance metric for presentation.

2. The method of claim 1, wherein receiving the digitized radar return data comprises receiving in-phase and quadrature (I/Q) samples produced by an analog-to-digital converter coupled to a radar front-end.

3. The method of claim 1, further comprising conditioning the digitized radar return data to reduce noise and non-projectile reflections prior to performing the frequency-domain analysis.

4. The method of claim 1, wherein performing the frequency-domain analysis comprises performing a Fast Fourier Transform (FFT) to generate a Doppler spectrum and identifying a Doppler peak associated with the sports projectile.

5. The method of claim 1, further comprising performing event segmentation on the digitized radar return data to isolate a time window corresponding to at least one of a projectile release event, an impact event, or a launch event.

6. The method of claim 1, wherein the radar-derived launch metrics comprise at least an initial projectile speed and at least one launch angle.

7. The method of claim 1, wherein the at least one additional feature comprises a radar echo feature derived from the digitized radar return data, the radar echo feature comprising at least one of a Doppler-spectrum-derived feature, a phase-derived feature, or a signal signature value associated with the sports projectile.

8. The method of claim 1, wherein the projectile-motion parameter comprises a rotational parameter including at least a spin rate.

9. The method of claim 1, wherein computing the user-facing sports performance metric comprises computing at least one of a landing point, carry distance, total distance, apex, angle of descent, or lateral deviation.

10. The method of claim 1, wherein the projectile-motion parameter is not output for presentation as the user-facing sports performance metric.

11. A computer-implemented method for generating sports performance metrics for a sports event involving a sports projectile, the method comprising:
receiving, by one or more processors, radar-derived launch metrics generated from radar return data produced by a radar sensor observing the sports projectile;
forming an input feature vector comprising the radar-derived launch metrics and an optional radar echo feature or context feature;
applying a machine-learning model to the input feature vector to generate a projectile-motion parameter;
computing, using a deterministic computation module, a user-facing sports performance metric from the projectile-motion parameter; and
outputting the user-facing sports performance metric for presentation.

12. The computer-implemented method of claim 11, wherein the radar-derived launch metrics comprise at least one of pitch speed, ball exit velocity, bat speed, release angle, or acceleration.

13. The computer-implemented method of claim 11, wherein the optional radar echo feature comprises a signature value derived from at least one of a Doppler spectrum representation or a Doppler-versus-time representation.

14. The computer-implemented method of claim 11, wherein the machine-learning model is configured to generate a plurality of projectile-motion parameters, including at least one rotational parameter and at least one trajectory-related parameter.

15. The computer-implemented method of claim 11, wherein the optional radar echo feature comprises an echo signature vector generated from at least one of conditioned I/Q samples, Doppler spectra, or tracked Doppler peak data, the echo signature vector including at least one of a modulation-pattern feature or a spectral-spread feature that characterizes how Doppler content evolves over time.

16. The computer-implemented method of claim 11, further comprising: determining whether a confidence score associated with the projectile-motion parameter exceeds a threshold; responsive to determining that the confidence score does not exceed the threshold, performing a fallback computation to compute a reduced or alternative set of user-facing sports performance metrics; and outputting the reduced or alternative set of metrics with a quality flag.

17. The computer-implemented method of claim 11, further comprising storing, for the sports event, at least the radar-derived launch metrics and the user-facing sports performance metric in association with a timestamp and a session identifier.

18. The computer-implemented method of claim 11, further comprising generating a confidence value associated with at least one of the radar-derived launch metrics or the projectile-motion parameter, and selectively applying smoothing to the user-facing sports performance metric based on the confidence value.

19. The computer-implemented method of claim 11, further comprising normalizing at least one of the radar-derived launch metrics, the projectile-motion parameter, or the user-facing sports performance metric based on an environmental condition or a device calibration factor.

20. A non-transitory computer-readable medium storing instructions that, when executed by one or more processors, cause the one or more processors to:
receive, by the one or more processors, radar-derived launch metrics generated from radar return data produced by a radar sensor observing the sports projectile;
form an input feature vector comprising the radar-derived launch metrics and an optional radar echo feature or context feature;
apply a machine-learning model to the input feature vector to generate a projectile-motion parameter;
compute, using a deterministic computation module, a user-facing sports performance metric from the projectile-motion parameter; and
output the user-facing sports performance metric for presentation.
